(19) United States
(12) Patent Application Publication
(10) Pub. No.: US 2026/0349313 A1
(43) Pub. Date: Nov. 5, 2026

(54) LENS-DRIVING DEVICE, CAMERA DEVICE, AND OPTICAL DEVICE

(71) Applicant: LG INNOTEK CO., LTD., Seoul (KR)

(72) Inventor: Sung Guk LEE, Seoul (KR)

(21) Appl. No.: 19/112,451

(22) PCT Filed: Jun. 30, 2023
(86) PCT No.: PCT/KR2023/009204

§ 371 Date: Mar. 17, 2025

(30) Foreign Application Priority Data
Sep. 15, 2022 (KR) 10-2022-0116711
Feb. 20, 2023 (KR) 10-2023-0022430

(51) Int. Cl. G03B 5/02; G02B 27/64; G03B 30/00; H04N 23/54; H04N 23/55; H04N 23/57; H04N 23/68

(52) U.S. Cl. CPC G03B 5/02; G02B 27/646; G03B 30/00; H04N 23/54; H04N 23/55; H04N 23/57; H04N 23/687; G03B 2205/0015; G03B 2205/0069

(57) ABSTRACT

The present embodiment relates to a lens-driving device comprising: a fixed unit; a first moving unit disposed in the fixed unit; a second moving unit disposed in the first moving unit; a third moving unit disposed in the second moving unit; a first drive unit which moves the first moving unit in a first direction perpendicular to the optical axis direction; a second drive unit which moves the second moving unit in a second direction perpendicular to the optical axis direction and the first direction; and a third drive unit which moves the third moving unit in the optical axis direction.

### TECHNICAL FIELD

The present embodiment relates to a lens-driving device, a camera device, and an optical device.

### BACKGROUND ART

A camera device is a device that photographs a picture or video of a subject, and is installed in optical instruments such as smartphones, drones, and vehicles.

An auto-focus function that automatically adjusts the focus according to the distance of the subject is applied to the camera device. In addition, a handshake correction function is applied to prevent a phenomenon in which the focus is shaken by the user's handshake.

However, in order to arrange configurations such as magnets and coils for performing the auto-focus function and the handshake correction function, a larger size than the thickness of the smartphone is required in the optical axis direction, so there is a problem that the camera device mounted on the smartphone is more protruded than other portions of the smartphone.

(Patent Literature 1) KR 10-2015-0118005 A

### DETAILED DESCRIPTION OF THE INVENTION

### Technical Subject

The present embodiment is to provide a camera device whose size in the optical axis direction is minimized even though it has an auto-focus function and a handshake correction function.

Furthermore, it is intended to provide a camera device in which the amount of current being consumed when driving the auto-focus (AF) is minimized.

### Technical Solution

A lens-driving device according to the present embodiment may comprise: a fixed unit; a first moving unit being disposed inside the fixed unit; a second moving unit being disposed inside the first moving unit; a third moving unit being disposed inside the second moving unit; a first drive unit which moves the first moving unit in a first direction perpendicular to the optical axis direction; a second drive unit which moves the second moving unit in a second direction perpendicular to the optical axis direction and the first direction; and a third drive unit which moves the third moving unit in the optical axis direction.

When the first moving unit is moved by the first drive unit, the second moving unit and the third moving unit can move together with the first moving unit.

When the second moving unit is moved by the second drive unit, the third moving unit can move together with the second moving unit.

The third drive unit comprises a third coil and a third magnet that interact with each other, and when the second moving unit and the third moving unit are moved by the second drive unit, the distance between the facing surfaces of the third coil and the third magnet can be changed.

The lens-driving device may comprise a first ball being disposed between the first moving unit and the fixed unit in the second direction.

The fixed unit comprises a groove, the first moving unit comprises a first groove, the first ball is disposed between the groove of the fixed unit and the first groove of the first moving unit, and at least one of the groove of the fixed unit and the first groove of the first moving unit can be extended in the first direction longer than the diameter of the first ball.

The first moving unit comprises a first portion being disposed between the second moving unit and the fixed unit in the first direction, and a second ball can be disposed between the first portion of the first moving unit and the second moving unit in the first direction.

The first moving unit comprises a second groove being formed in the first portion of the first moving unit, the second moving unit comprises a first groove, the second ball is disposed between the second groove of the first moving unit and the first groove of the second moving unit, and at least one of the second groove of the first moving unit and the first groove of the second moving unit can be extended in the second direction longer than the diameter of the second ball.

The second moving unit comprises a first portion being disposed between the third moving unit and the fixed unit in the second direction, and a third ball can be disposed between the first portion of the second moving unit and the third moving unit in the second direction.

The second moving unit comprises a second groove being formed in the first portion of the second moving unit, the third moving unit comprises a groove, the third ball is disposed between the second groove of the second moving unit and the groove of the third moving unit, and at least one of the second groove of the second moving unit and the groove of the third moving unit can be extended longer than the diameter of the third ball in the optical axis direction.

The fixed unit comprises a substrate, the first drive unit comprises a first magnet being disposed on the first moving unit, and a first coil being disposed at a position corresponding to the first magnet in the substrate, and at least a portion of the first ball can be overlapped with the first magnet in the first direction.

The fixed unit comprises a substrate, the second drive unit comprises a second magnet being disposed in the second moving unit, and a second coil being disposed at a position corresponding to the second magnet in the substrate, and at least a portion of the second ball can be overlapped with the second magnet in the second direction.

The fixed unit comprises a substrate, the third drive unit comprises a third magnet being disposed on the third moving unit, and a third coil disposed on the substrate at a position corresponding to the third magnet, and at least a portion of the third ball can be overlapped with the third magnet in the first direction.

The first drive unit may comprise a first magnet being disposed in the first moving unit, and a first yoke in which an attractive force act the first magnet may be disposed in the fixed unit.

The second drive unit may comprise a second magnet being disposed in the second moving unit, and a second yoke that exerts an attractive force on the second magnet may be disposed in the first moving unit.

The second yoke may comprise a first portion being disposed on one side of the second magnet in the second direction, and a second portion being disposed on the other side of the second magnet in the second direction, and the second magnet may comprise a chamfer surface being formed at a corner closest to each of the first portion and the second portion of the second yoke.

The third drive unit may comprise a third magnet disposed in the third moving unit, and a third yoke that exerts an attractive force on the third magnet may be disposed in the second moving unit.

The third yoke may comprise a first portion being disposed on one side of the third magnet in the first direction, and a second portion being disposed on the other side of the third magnet in the first direction, and the third magnet may comprise a chamfer surface being formed at an edge closest to each of the first portion and the second portion of the third yoke.

A camera device according to the present embodiment may comprise a printed circuit board; an image sensor being disposed in the printed circuit board; the lens-driving device being disposed in the printed circuit board; and a lens being coupled to the lens-driving device.

An optical device according to the present embodiment may comprise a main body; the camera device being disposed in the main body; and a display being disposed in the main body and outputting at least one of an image and a video photographed by the camera device.

### Advantageous Effects

Through the present embodiment, an auto focus function and an image stabilization function can be performed in a camera device with a size minimized in an optical axis direction.

That is, according to the present embodiment, both the auto focus function and the handshake correction function can be performed even though the camera device is not protruded from the smartphone.

Furthermore, through the present embodiment, a camera device having a minimized size in horizontal and vertical directions perpendicular to an optical axis can be provided.

In addition, the amount of current consumed during auto focus (AF) driving can be minimized, which can increase the usage time of the smartphone.

### BRIEF DESCRIPTION OF DRAWINGS

FIG. 1 is a perspective view of a lens-driving device according to the present embodiment.

FIG. 2 is a cross-sectional view taken along line A-A of FIG. 1.

FIG. 3 is a cross-sectional view taken along line B-B of FIG. 1.

FIG. 4 is a cross-sectional view taken along line C-C of FIG. 1.

FIG. 5 is a cross-sectional view taken along line D-D of FIG. 1.

FIG. 6 is a cross-sectional view taken along line A-B of FIG. 1 according to the present embodiment, cut in a direction perpendicular to the optical axis and viewed from above.

FIG. 7 is a cross-sectional view taken along line A-B of FIG. 1 according to the present embodiment, cut in a direction perpendicular to the optical axis and viewed from above so that an OIS guide ball is visible.

FIG. 8 is an exploded perspective view of a lens-driving device according to the present embodiment.

FIG. 9 is an exploded perspective view taken from a different direction from FIG. 8.

FIG. 10 is a perspective view of a lens-driving device according to the present embodiment with a cover removed.

FIG. 11 is a perspective view of FIG. 10 with the moving unit removed.

FIG. 12 is a perspective view of FIG. 11 viewed from a different direction.

FIG. 13 is a perspective view illustrating a moving unit of a lens-driving device according to the present embodiment.

FIG. 14 is a perspective view of FIG. 13 viewed from a different direction.

FIG. 15 is a bottom view of a lens-driving device according to the present embodiment.

FIG. 16 is a perspective view illustrating a first moving unit and related components of a lens-driving device according to the present embodiment.

FIG. 17 is a perspective view illustrating a second moving unit and related components of a lens-driving device according to the present embodiment.

FIG. 18 is a perspective view of FIG. 17 viewed from a different direction.

FIG. 19 is a perspective view illustrating a third moving unit and related components of a lens-driving device according to the present embodiment.

FIG. 20 is a perspective view illustrating a substrate, coil, and related components of a lens-driving device according to the present embodiment.

FIG. 21 is a perspective view illustrating a coil and a magnet of a lens-driving device according to the present embodiment.

FIG. 22 is a cross-sectional perspective view of a lens-driving device according to a modified embodiment.

FIG. 23 is a perspective view illustrating a moving unit and related components of a lens-driving device according to a modified embodiment.

FIG. 24 is a perspective view illustrating a coil, a magnet, a yoke, a ball, and a sensor of a lens-driving device according to a modified embodiment.

FIG. 25 is a perspective view illustrating a moving unit and related components of a lens-driving device according to a modified embodiment from a different direction than FIG. 23.

FIG. 26 is a perspective view illustrating an AF magnet, an AF yoke, an AF guide ball, and an AF sensor of a lens-driving device according to a modified embodiment.

FIGS. 27 to 29 are diagrams for explaining an auto focus driving of a lens-driving device according to the present embodiment. FIG. 27 is a cross-sectional view illustrating an appearance of the AF moving unit in an initial state in which no current is applied to an AF coil. FIG. 28 is a cross-sectional view illustrating an appearance in which an AF moving unit moves upward in an optical axis direction when a forward current is applied to an AF coil. FIG. 29 is a cross-sectional view illustrating an appearance in which an AF moving unit moves downward in an optical axis direction when a reverse current is applied to an AF coil.

FIGS. 30 to 32 are diagrams for explaining a handshake correction driving of a lens-driving device according to the present embodiment. FIG. 30 is a cross-sectional view illustrating the appearance of a moving unit in an initial state in which no current is applied to an OIS-y coil and an OIS-x coil. FIG. 31 is a cross-sectional view illustrating an appearance in which an OIS-x moving unit, an OIS-y moving unit, and an AF moving unit that have been moved in a y-axis direction perpendicular to the optical axis when current is applied to an OIS-y coil. FIG. 32 is a cross-sectional view illustrating an appearance in which an OIS-x moving unit and an AF moving unit that have been moved in an x-axis direction perpendicular to the optical axis when current is applied to an OIS-x coil.

FIG. 33 is an exploded perspective view of a camera device according to the present embodiment.

FIG. 34 is a perspective view of an optical device according to the present embodiment.

FIG. 35 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised.

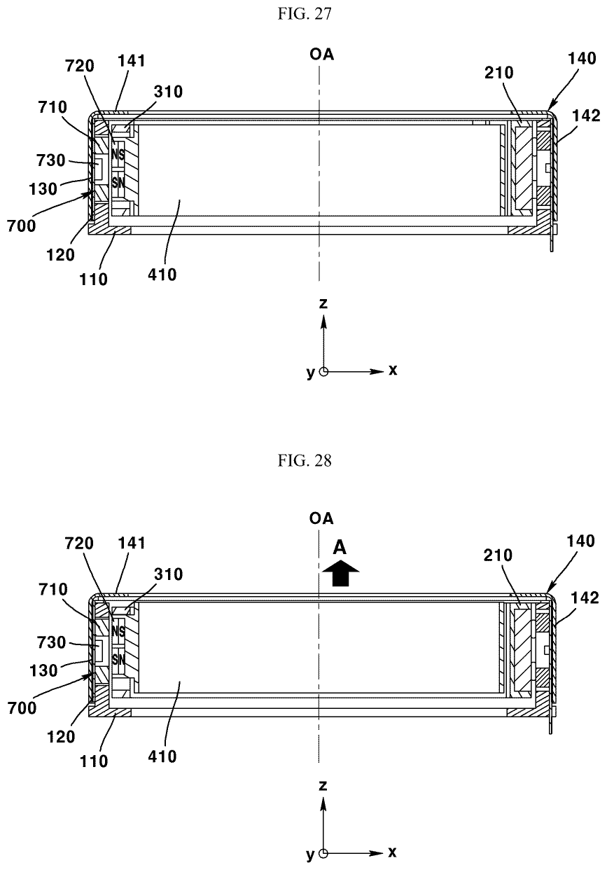

The ‘optical axis (see OA of FIG. 27) direction’ used hereinafter is defined as an optical axis direction of a lens and/or image sensor being coupled to a lens-driving device.

The ‘vertical direction’ used hereinafter may be a direction parallel to or the same as an optical axis direction. The vertical direction may correspond to a ‘z-axis direction’. The ‘horizontal direction’ used hereinafter may be a direction perpendicular to a vertical direction. That is, a horizontal direction may be a direction perpendicular to the optical axis. Therefore, a horizontal direction may comprise an ‘x-axis direction’ and a ‘y-axis direction’.

The ‘auto focus (AF) function’ used hereinafter is defined as a function that automatically focuses on a subject by adjusting the distance from an image sensor by moving the lens in an optical axis direction according to the distance of the subject so that a clear image of the subject can be obtained on an image sensor. In addition, ‘closed-loop auto focus (CLAF) control’ is defined as detecting the distance between an image sensor and a lens and controlling the position of the lens through feedback in real time in order to improve the accuracy of focus adjustment.

The ‘optical image stabilization (OIS) function’ used hereinafter is defined as a function that moves or tilts a lens in a direction perpendicular to the optical axis to offset handshake in order to prevent an image or video from shaking due to the user's handshake. In addition, ‘closed-loop auto focus (CLAF) control’ is defined as detecting the position of a lens with respect to an image sensor and controlling the feedback of the lens position in real time in order to improve the accuracy of handshake correction.

Hereinafter, any one among an “OIS-y moving unit 200”, an “OIS-x moving unit 300”, and an “AF moving unit 400” may be referred to as a “first moving unit”, the other may be referred to as a “second moving unit”, and yet the other may be referred to as a “third moving unit”.

Hereinafter, any one among an “OIS-y drive unit 500”, an “OIS-x drive unit 600”, and an “AF drive unit 700” may be referred to as a “first drive unit”, the other may be referred to as a “second drive unit”, and yet the other may be referred to as a “third drive unit”.

Hereinafter, any one among an “OIS-y coil 510”, an “OIS-x coil 610”, and an “AF coil 710” may be referred to as a “first coil”, the other may be referred to as a “second coil”, and yet the other may be referred to as a “third coil”.

Hereinafter, any one among an “OIS-y magnet 520”, an “OIS-x magnet 620”, and an “AF magnet 720” may be referred to as a “first magnet”, the other may be referred to as a “second magnet”, and yet the other may be referred to as a “third magnet”.

Hereinafter, any one among an “OIS-y sensor 530”, an “OIS-x sensor 630”, and an “AF sensor 730” may be referred to as a “first sensor”, the other may be referred to as a “second sensor”, and yet the other may be referred to as a “third sensor”.

Hereinafter, any one among an “OIS-y guide ball 810”, an “OIS-x guide ball 820”, and an “AF guide ball 830” may be referred to as a “first ball”, the other may be referred to as a “second ball”, and yet the other may be referred to as a “third ball”.

Hereinafter, any one of an “x-axis direction” and a “y-axis direction” may be referred to as a “first direction” and the other may be referred to as a “second direction”.

Hereinafter, any one among an “OIS-y yoke 131”, an “OIS-x yoke 132”, and an “AF yoke 133” may be referred to as a “first yoke”, the other may be referred to as a “second yoke”, and yet the other may be referred to as a “third yoke”.

Hereinafter, any one among an “OIS-y yoke 910”, an “OIS-x yoke 920”, and an “AF yoke 930” may be referred to as a “first yoke”, the other may be referred to as a “second yoke”, and yet the other may be referred to as a “third yoke”.

Hereinafter, a configuration of a lens-driving device according to the present embodiment is described with reference to the drawings.

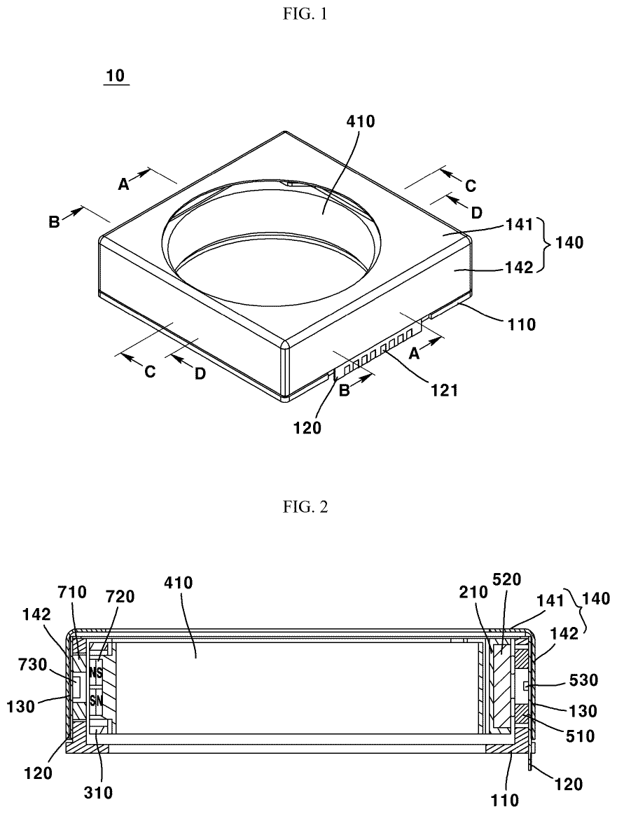

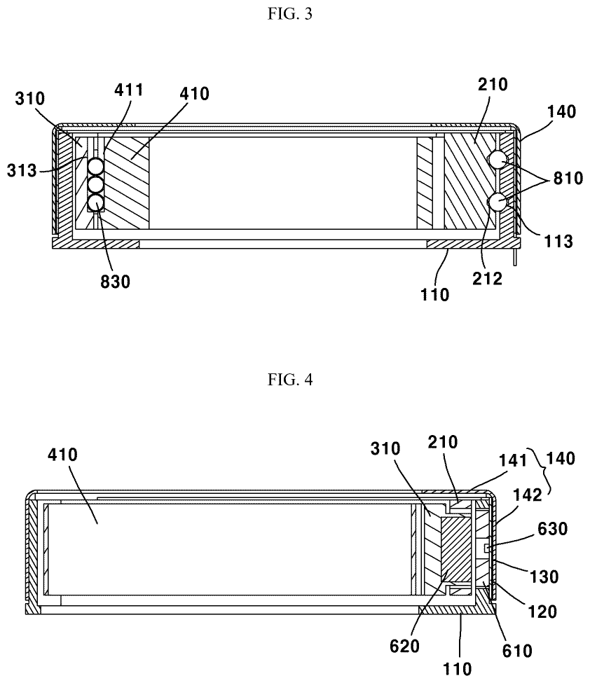

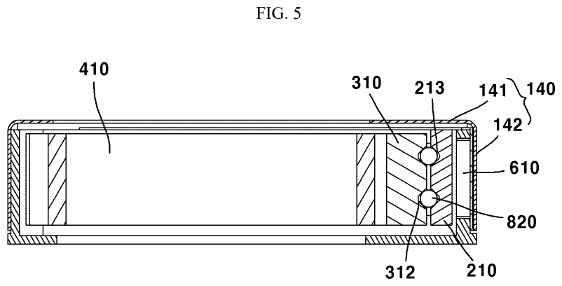

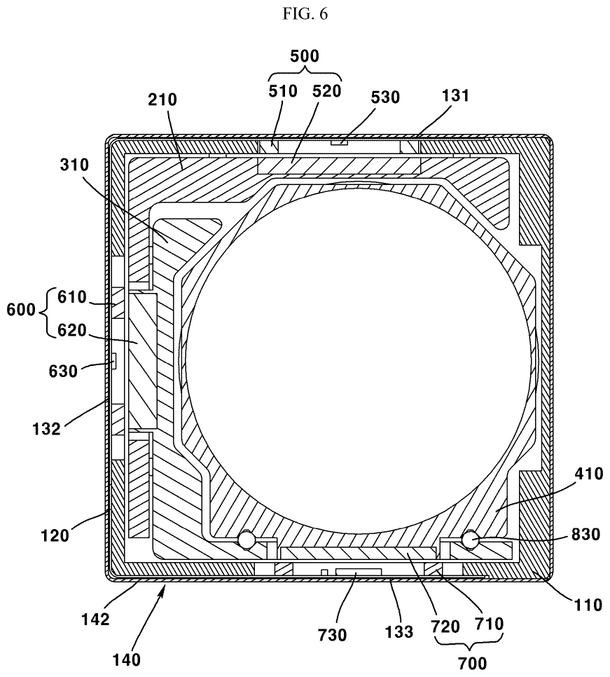

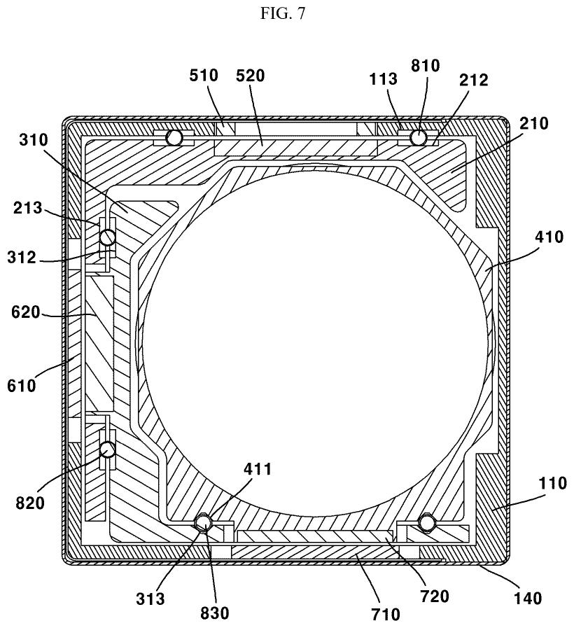

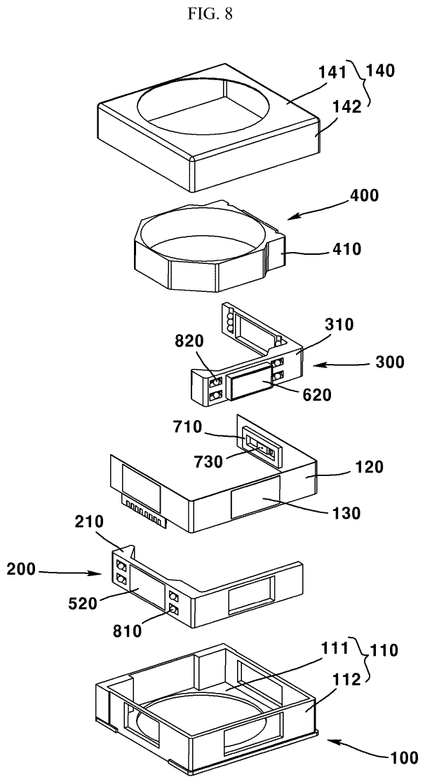

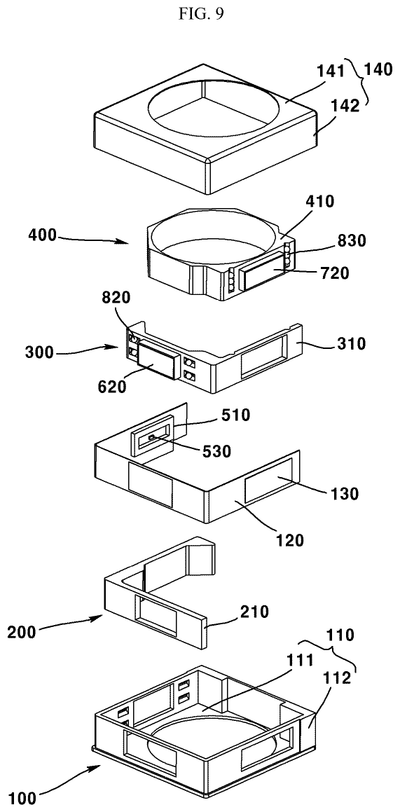

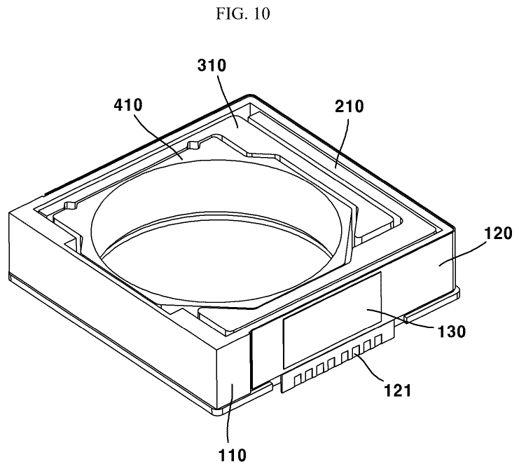

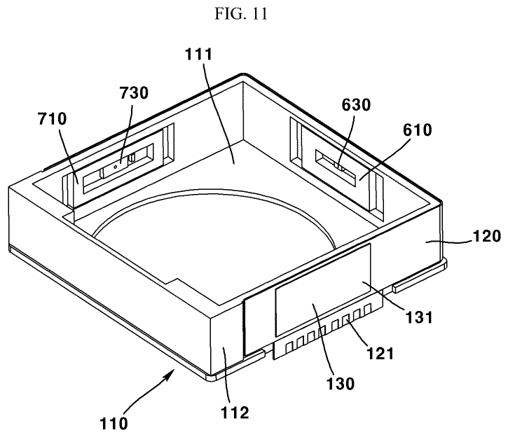

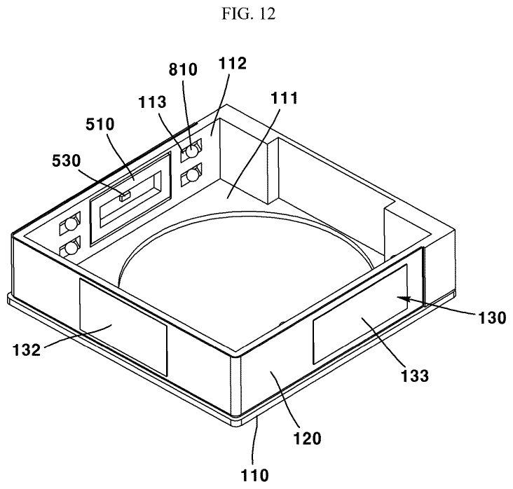

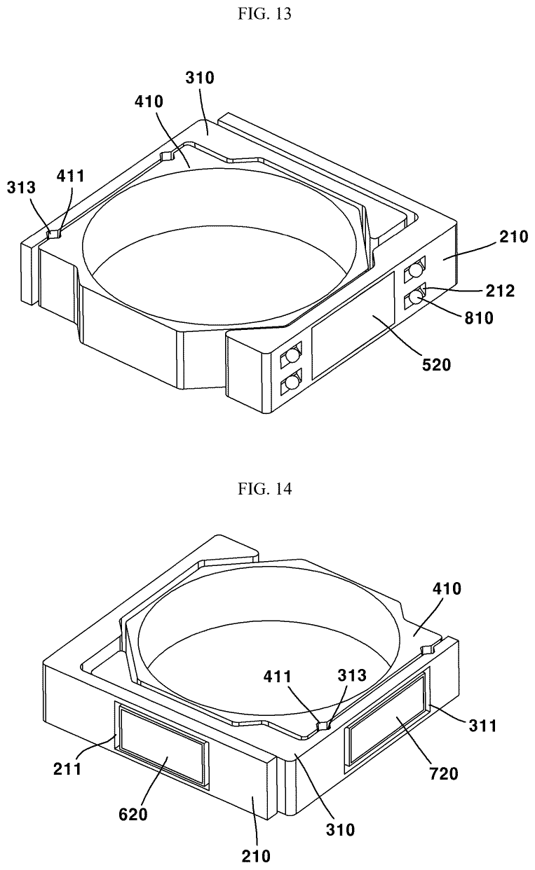

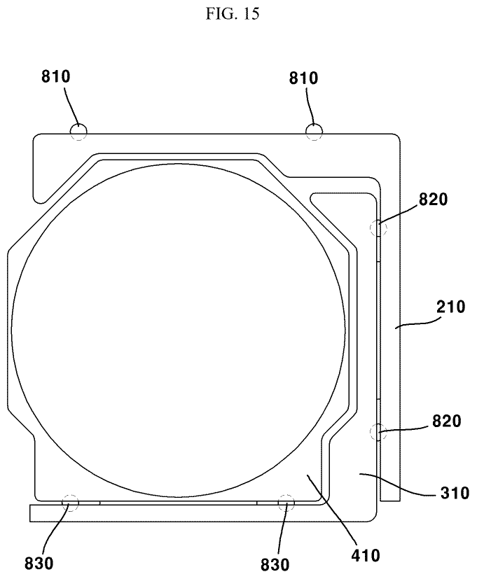

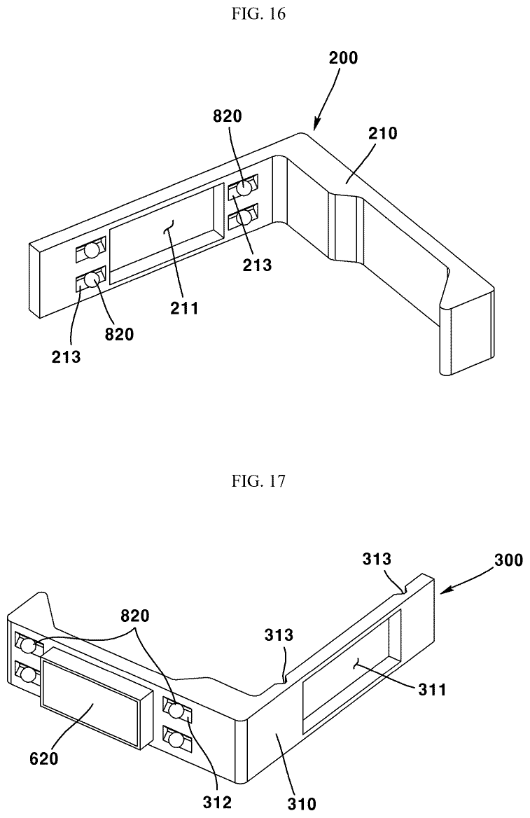

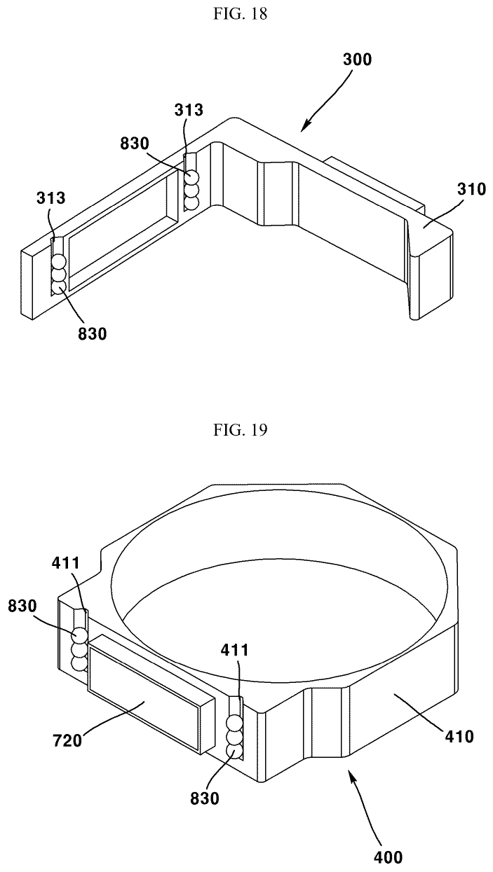

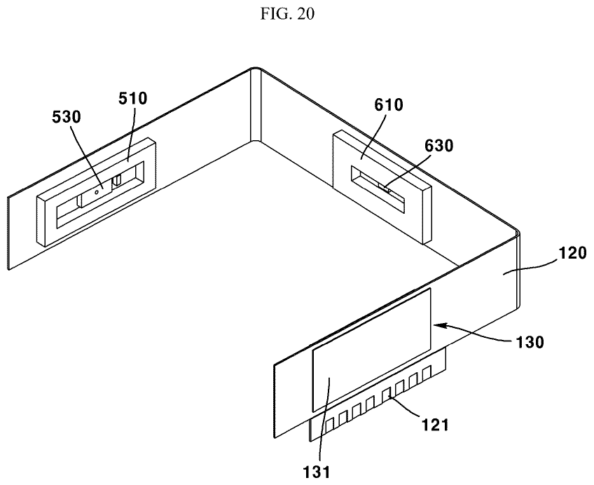

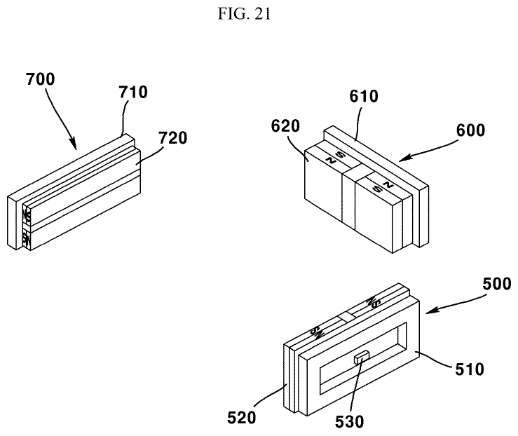

FIG. 1 is a perspective view of a lens-driving device according to the present embodiment; FIG. 2 is a cross-sectional view taken along line A-A of FIG. 1; FIG. 3 is a cross-sectional view taken along line B-B of FIG. 1; FIG. 4 is a cross-sectional view taken along line C-C of FIG. 1; FIG. 5 is a cross-sectional view taken along line D-D of FIG. 1; FIG. 6 is a cross-sectional view taken along line A-B of FIG. 1 according to the present embodiment, cut in a direction perpendicular to the optical axis and viewed from above; FIG. 7 is a cross-sectional view taken along line A-B of FIG. 1 according to the present embodiment, cut in a direction perpendicular to the optical axis and viewed from above so that an OIS guide ball is visible; FIG. 8 is an exploded perspective view of a lens-driving device according to the present embodiment; FIG. 9 is an exploded perspective view taken from a different direction from FIG. 8; FIG. 10 is a perspective view of a lens-driving device according to the present embodiment with a cover removed; FIG. 11 is a perspective view of FIG. 10 with the moving unit removed; FIG. 12 is a perspective view of FIG. 11 viewed from a different direction; FIG. 13 is a perspective view illustrating a moving unit of a lens-driving device according to the present embodiment; FIG. 14 is a perspective view of FIG. 13 viewed from a different direction; FIG. 15 is a bottom view of a lens-driving device according to the present embodiment; FIG. 16 is a perspective view illustrating a first moving unit and related components of a lens-driving device according to the present embodiment; FIG. 17 is a perspective view illustrating a second moving unit and related components of a lens-driving device according to the present embodiment; FIG. 18 is a perspective view of FIG. 17 viewed from a different direction; FIG. 19 is a perspective view illustrating a third moving unit and related components of a lens-driving device according to the present embodiment; FIG. 20 is a perspective view illustrating a substrate, coil, and related components of a lens-driving device according to the present embodiment; and FIG. 21 is a perspective view illustrating a coil and a magnet of a lens-driving device according to the present embodiment.

The lens-driving device 10 may be a voice coil motor (VCM). The lens-driving device 10 may be a lens driving motor. The lens-driving device 10 may be a lens driving actuator. The lens-driving device 10 may comprise an AF module. The lens-driving device 10 may comprise an OIS module.

The lens-driving device 10 may comprise a fixed unit 100. The fixed unit 100 may be a portion that is relatively fixed when the moving unit moves. The moving unit may move with respect to the fixed unit 100.

The lens-driving device 10 may comprise a base 110. The fixed unit 100 may comprise a base 110. The base 110 may be disposed under the OIS-y holder 210. The base 110 may be disposed under the OIS-x holder 310. The base 110 may be disposed under the AF holder 410. The base 110 may be coupled with the cover 140. The OIS-y holder 210, the OIS-x holder 310, and the AF holder 410 may be disposed on the base 110. The OIS-y holder 210, the OIS-x holder 310, and the AF holder 410 may be disposed on the lower plate 111 of the base 110. The OIS-y holder 210, the OIS-x holder 310, and the AF holder 410 can be disposed inside the base 110. The OIS-y holder 210, the OIS-x holder 310, and the AF holder 410 can be disposed inside the side plate 112 of the base 110.

The base 110 may comprise a lower plate 111. The base 110 may comprise a side plate 112. The side plate 112 of the base 110 may be a ‘side portion’. The side plate 112 of the base 110 may be extended from an upper surface of the lower plate 111. The side plate 112 of the base 110 may comprise a plurality of side plates. The side plate 112 of the base 110 may comprise four side plates. The base 110 may comprise a first side portion and a second side portion which are disposed opposite to each other, and a third side portion and a fourth side portion which are disposed opposite to each other. At this time, the OIS-x coil 610 may be disposed at a position corresponding to a third side portion of the base 110. The distance between an optical axis and a fourth side portion of the base 110 may be closer than the distance between an optical axis and a third side portion of the base 110. That is, the optical axis may be disposed to be offset from the central axis of the base 110 toward a fourth side portion of the base 110.

The base 110 may comprise a groove 113. The groove 113 may be an ‘OIS-y guide ball accommodating groove’. An OIS-y guide ball 810 may be disposed in the groove 113. The groove 113 may be in direct contact with the OIS-y guide ball 810. The groove 113 may be disposed in a y-axis direction perpendicular to the optical axis. The groove 113 may comprise a plurality of grooves. The groove 113 may comprise four grooves. The four grooves may be disposed parallel to each other. The groove 113 may comprise a first groove being in contact with the OIS-y guide ball 810 at two points, and a second groove being in contact with the OIS-y guide ball 810 at one point. As a modified embodiment, both a first groove and a second groove may be in contact with the OIS-y guide ball 810 at two points.

The lens-driving device 10 may comprise a substrate 120. The fixed unit 100 may comprise a substrate 120. The substrate 120 may be disposed in a base 110. The substrate 120 may be disposed in a side plate 112 of the base 110. The substrate 120 may be disposed on an outer surface of a side plate 142 of a cover 140. The substrate 120 may be disposed parallel to an optical axis. The substrate 120 may be a circuit board. The substrate 120 may be a printed circuit board. The substrate 120 may comprise a flexible printed circuit board (FPCB). The substrate 120 may be flexible. The substrate 120 may be bent. The substrate 120 may be bent multiple times. The substrate 120 can be bent twice.

The substrate 120 may comprise a first portion and a third portion being disposed on opposite sides, and a second portion which connects the first portion and the third portion. At this time, the OIS-y coil 510 may be disposed in a first portion of the substrate 120. The OIS-x coil 610 may be disposed in a second portion of the substrate 120. The AF coil 710 may be disposed in a third portion of the substrate 120.

The substrate 120 may comprise a body portion. Coils 510, 610, and 710 may be disposed in the body portion. The substrate 120 may comprise a terminal portion 121. The terminal portion 121 may be extended downward from the body portion. The terminal portion 121 may be formed at a lower end portion of the substrate 120. The terminal portion 121 may be protruded downward from the base 110. The terminal portion 121 may comprise a terminal.

The terminal portion 121 may comprise a plurality of terminals. The terminal of the substrate 120 may be electrically connected to the coils 510, 610, and 710. The terminal of the substrate 120 may be electrically connected to the OIS-y coil 510. The terminal of the substrate 120 may be electrically connected to the OIS-x coil 610. The terminal of the substrate 120 may be electrically connected to the AF coil 710. The terminal of the substrate 120 may be electrically connected to the sensors 530, 630, and 730. The terminal of the substrate 120 may be electrically connected to the OIS-y sensor 530. The terminal of the substrate 120 may be electrically connected to the OIS-x sensor 630. The terminal of the substrate 120 may be electrically connected to the AF sensor 730. The terminal portion 121 can be coupled to a printed circuit board 50. The terminal portion 121 can be coupled to the printed circuit board 50 via solder. The terminal portion 121 can be coupled to the printed circuit board 50 via a conductive member.

The lens-driving device 10 may comprise a yoke 130. The fixed unit 100 may comprise a yoke 130. The yoke 130 may be an ‘attractive force member’. The yoke 130 may be a ‘ball pressure member’. The yoke 130 may be formed of metal. A force may be generated between the yoke 130 and the magnets 520, 620, and 720. The balls 810, 820, and 830 may be pressed by the force between the yoke 130 and the magnets 520, 620, and 720. The yoke 130 may be disposed in the substrate 120. The yoke 130 may be disposed on an outer side surface of the substrate 120.

The yoke 130 may comprise a plurality of yokes. The yoke 130 may comprise three yokes. The yoke 130 may comprise an OIS-y yoke 131, an OIS-x yoke 132, and an AF yoke 133. The OIS-y yoke 131, the OIS-x yoke 132, and the AF yoke 133 may be spaced apart from one another.

The yoke 130 may comprise an OIS-y yoke 131. The OIS-y yoke 131 may be disposed in the first portion of the substrate 120. The OIS-y yoke 131 may be disposed on an outer surface of the first portion of the substrate 120. The OIS-y yoke 131 may be disposed at a position corresponding to the OIS-y magnet 520. An attractive force may be generated between the OIS-y yoke 131 and the OIS-y magnet 520. The OIS-y guide ball 810 may be pressurized by the attractive force between the OIS-y yoke 131 and the OIS-y magnet 520. The OIS-y guide ball 810 can be pressurized between the OIS-y holder 210 and the base 110 by the attractive force between the OIS-y yoke 131 and the OIS-y magnet 520.

The yoke 130 may comprise an OIS-x yoke 132. The OIS-x yoke 132 may be disposed in the second portion of the substrate 120. The OIS-x yoke 132 may be disposed on an outer surface of the second portion of the substrate 120. The OIS-x yoke 132 may be disposed at a position corresponding to the OIS-x magnet 620. An attractive force may be generated between the OIS-x yoke 132 and the OIS-x magnet 620. The OIS-x guide ball 820 may be pressurized by the attractive force between the OIS-x yoke 132 and the OIS-x magnet 620. The OIS-x guide ball 820 can be pressurized between the OIS-x holder 310 and the OIS-y holder 210 by the attractive force between the OIS-x yoke 132 and the OIS-x magnet 620.

The yoke 130 may comprise an AF yoke 133. The AF yoke 133 may be disposed in the third portion of the substrate 120. The AF yoke 133 may be disposed on an outer surface of the third portion of the substrate 120. The AF yoke 133 may be disposed at a position corresponding to the AF magnet 720. An attractive force may be generated between the AF yoke 133 and the AF magnet 720. The AF guide ball 830 may be pressed by the attractive force between the AF yoke 133 and the AF magnet 720. The AF guide ball 830 may be pressed between the AF holder 410 and the OIS-x holder 310 by the attractive force between the AF yoke 133 and the AF magnet 720.

The lens-driving device 10 may comprise a cover 140. The fixed unit 100 may comprise a cover 140. The cover 140 may be disposed in the base 110. The cover 140 may be coupled to the base 110. The cover 140 may be fixed to the base 110. The cover 140 may accommodate an OIS-y holder 210 therein. The cover 140 may accommodate an OIS-x holder 310 therein. The cover 140 may accommodate an AF holder 410 therein. The cover 140 may be a shield member. The cover 140 may be a shield can.

The cover 140 may comprise an upper plate 141. The upper plate 141 may be disposed on the moving unit. The upward movement of the moving unit may be limited by the moving unit being in contact with the upper plate 141. The upper plate 141 may comprise a hole through which light passes.

The cover 140 may comprise a side plate 142. The side plate 142 may be extended from the upper plate 141. The side plate 142 may be disposed on the base 110. The side plate 142 may be disposed on a step portion being protruded from a lower end portion of an outer surface of the base 110. The side plate 142 may comprise a plurality of side plates. The side plate 142 may comprise four side plates. The side plate 142 may comprise a first side plate and a second side plate being disposed opposite to each other, and a third side plate and a fourth side plate being disposed opposite to each other.

The lens-driving device 10 may comprise a moving unit. The moving unit may be disposed in the fixed unit 100. The moving unit may be disposed inside the fixed unit 100. The moving unit may be disposed on the fixed unit 100. The moving unit may be movably disposed on the fixed unit 100. The moving unit may be moved with respect to the fixed unit 100 by the drive unit. The moving unit may be moved during AF driving. The moving unit may be moved during OIS driving. A lens may be coupled to the moving unit.

The lens-driving device 10 may comprise an OIS-y moving unit 200. The OIS-y moving unit 200 may be disposed in the fixed unit 100. The OIS-y moving unit 200 may be disposed inside the fixed unit 100. The OIS-y moving unit 200 may be disposed on the fixed unit 100. The OIS-y moving unit 200 may be disposed between the fixed unit 100 and the OIS-x moving unit 300. The OIS-y moving unit 200 may be disposed between the fixed unit 100 and the AF moving unit 400. The OIS-y moving unit 200 may be movably disposed in the fixed unit 100. The OIS-y moving unit 200 may move in a y-axis direction with respect to the fixed unit 100 by the OIS-y drive unit 500. The OIS-y moving unit 200 can move during OIS driving.

The OIS-y moving unit 200 may comprise a first portion disposed between the OIS-x moving unit 300 and the fixed unit 100 in a y-axis direction. An OIS-x guide ball 820 may be disposed between the first portion of the OIS-y moving unit 200 and the OIS-x moving unit 300 in a y-axis direction. The OIS-y moving unit 200 may comprise a second groove 213 being formed in a first portion of the OIS-y moving unit 200.

The lens-driving device 10 may comprise an OIS-y holder 210. The OIS-y moving unit 200 may comprise an OIS-y holder 210. The OIS-y holder 210 may be an ‘OIS-y carrier’. The OIS-y holder 210 may be disposed inside the base 110. The OIS-y holder 210 may be disposed on the base 110. The OIS-y holder 210 may be disposed inside the cover 140. The OIS-y holder 210 may be disposed between the base 110 and the OIS-x holder 310. The OIS-y holder 210 may be disposed between the base 110 and the AF holder 410. The OIS-y holder 210 can be disposed so as to be movable in a y-axis direction.

In an optical axis direction, the OIS-y holder 210 may not be overlapped with both the OIS-x holder 310 and the AF holder 410. The OIS-y holder 210 may be overlapped with the OIS-x holder 310 and the AF holder 410 in a direction perpendicular to the optical axis. As a modified embodiment, a stopper may be formed in the OIS-y holder 210. At this time, the stopper of the OIS-y holder 210 may be overlapped with at least one of the OIS-x holder 310 and the AF holder 410 in an optical axis direction.

The OIS-y holder 210 may comprise a hole 211. The hole 211 may be an ‘OIS-x holder avoidance hole’. The hole 211 may be formed on a side plate of the OIS-y holder 210. The hole 211 may penetrate the OIS-y holder 210 in a y-axis direction. As a modified embodiment, the hole 211 may be formed as a groove being recessed from an upper surface of the OIS-y holder 210 or a groove being recessed from a lower surface. A portion of the OIS-x holder 310 may be disposed in the hole 211. A protruded portion of the OIS-x holder 310 may be disposed in the hole 211. An OIS-x magnet 620 may be disposed in the hole 211.

The OIS-y holder 210 may comprise a first groove 212. The first groove 212 may be an ‘OIS-y guide ball accommodating groove’. An OIS-y guide ball 810 may be disposed in the first groove 212. The first groove 212 may be in direct contact with the OIS-y guide ball 810. The first groove 212 may be disposed in a y-axis direction. The first groove 212 may comprise a plurality of grooves. The first groove 212 may comprise four grooves. The four grooves may be disposed parallel to each other. The first groove 212 may comprise a first groove being in contact with the OIS-y guide ball 810 at two points, and a second groove being in contact with the OIS-y guide ball 810 at one point. In a modified embodiment, both the first groove and the second groove can come into contact with the OIS-y guide ball 810 at two points.

The OIS-y holder 210 may comprise a second groove 213. The second groove 213 may be an ‘OIS-x ball accommodating groove’. An OIS-x guide ball 820 may be disposed in the second groove 213. The second groove 213 may be in direct contact with the OIS-x guide ball 820. The second groove 213 may be disposed in an x-axis direction. The second groove 213 may comprise a plurality of grooves. The second groove 213 may comprise four grooves. The second groove 213 may comprise a first groove being in contact with the OIS-x guide ball 820 at two points, and a second groove being in contact with the OIS-x guide ball 820 at one point. In a modified embodiment, both the first groove and the second groove can make contact with the OIS-x guide ball 820 at two points.

The OIS-y holder 210 may comprise a groove. The groove may be an ‘OIS-y magnet accommodating groove’. The groove may be formed on an outer surface of the OIS-y holder 210. An OIS-y magnet 520 may be disposed in the groove. The groove may be formed in a shape corresponding to the OIS-y magnet 520.

The OIS-y holder 210 may comprise a groove. The groove may be formed concavely on an inner side surface of the OIS-y holder 210. An AF holder 410 may be disposed in the groove. An OIS-y magnet 520 may be disposed on the opposite side of the groove.

The lens-driving device 10 may comprise an OIS-x moving unit 300. The OIS-x moving unit 300 may be disposed in the fixed unit 100. The OIS-x moving unit 300 may be disposed inside the fixed unit 100. The OIS-x moving unit 300 may be disposed on the fixed unit 100. The OIS-x moving unit 300 may be disposed inside the OIS-y moving unit 200. The OIS-x moving unit 300 may be disposed between the fixed unit 100 and the AF moving unit 400. The OIS-x moving unit 300 may be disposed between the OIS-y moving unit 200 and the AF moving unit 400. The OIS-x moving unit 300 may be movably disposed. The OIS-x moving unit 300 can move in an x-axis direction against the fixed unit 100 and the OIS-y moving unit 200 by the OIS-x drive unit 600. The OIS-x moving unit 300 can move during OIS driving.

The OIS-x moving unit 300 may comprise a first portion disposed between the AF moving unit 400 and the fixed unit 100 in an x-axis direction. An AF guide ball 830 may be disposed between a first portion of the OIS-x moving unit 300 and the AF moving unit 400 in an x-axis direction. The OIS-x moving unit 300 may comprise a second groove 313 being formed in a first portion of the OIS-x moving unit 300.

The lens-driving device 10 may comprise an OIS-x holder 310. The OIS-x moving unit 300 may comprise an OIS-x holder 310. The OIS-x holder 310 may be an ‘OIS-x carrier’. The OIS-x holder 310 may be disposed inside the OIS-y holder 210. The OIS-x holder 310 may be disposed inside the base 110. The OIS-x holder 310 may be disposed on the base 110. The OIS-x holder 310 may be disposed inside the cover 140. The OIS-x holder 310 may be disposed between the base 110 and the AF holder 410. The OIS-x holder 310 may be disposed between the OIS-y holder 210 and the AF holder 410. The OIS-x holder 310 may be movably disposed in an x-axis direction. The OIS-x holder 310 may comprise a portion being disposed between the OIS-y holder 210 and the AF holder 410 in a y-axis direction.

The OIS-x holder 310 may comprise a hole 311. The hole 311 may be an ‘AF holder avoidance hole’. The hole 311 may be formed on a side plate of the OIS-x holder 310. The hole 311 may penetrate the OIS-x holder 310 in an x-axis direction. In a modified embodiment, the hole 311 may be formed as a groove being recessed from an upper surface of the OIS-x holder 310 or a groove being recessed from a lower surface. A portion of the AF holder 410 may be disposed in the hole 311. A protruded portion of the AF holder 410 may be disposed in the hole 311. An AF magnet 720 may be disposed in the hole 311.

The OIS-x holder 310 may comprise a first groove 312. The first groove 312 may be an ‘OIS-x guide ball accommodating groove’. An OIS-x guide ball 820 may be disposed in the first groove 312. The first groove 312 may be in direct contact with the OIS-x guide ball 820. The first groove 312 may be disposed in an x-axis direction. The first groove 312 may comprise a plurality of grooves. The first groove 312 may comprise four grooves. The first groove 312 may comprise a first groove being in contact with the OIS-x guide ball 820 at two points, and a second groove being in contact with the OIS-x guide ball 820 at one point. In a modified embodiment, both the first groove and the second groove can make contact with the OIS-x guide ball 820 at two points.

The OIS-x holder 310 may comprise a second groove 313. The second groove 313 may be an ‘AF guide ball accommodating groove’. An AF guide ball 830 may be disposed in the second groove 313. The second groove 313 may be in direct contact with the AF guide ball 830. The second groove 313 may be disposed in an optical axis direction. The second groove 313 may comprise a plurality of grooves. The second groove 313 may comprise two grooves. The second groove 313 may comprise a first groove being in contact with the AF guide ball 830 at two points, and a second groove being in contact with the AF guide ball 830 at one point. In a modified embodiment, both the first groove and the second groove may be in contact with the AF guide ball 830 at two points.

The OIS-x holder 310 may comprise a groove. The groove may be an ‘OIS-x magnet accommodating groove’. The groove may be formed on an outer surface of the OIS-x holder 310. An OIS-x magnet 620 may be disposed in the groove. The groove may be formed in a shape corresponding to the OIS-x magnet 620.

The lens-driving device 10 may comprise an AF moving unit 400. The AF moving unit 400 may be disposed in the fixed unit 100. The AF moving unit 400 may be disposed inside the fixed unit 100. The AF moving unit 400 may be disposed on the fixed unit 100. The AF moving unit 400 may be disposed inside the OIS-y moving unit 200. The AF moving unit 400 may be disposed inside the OIS-x moving unit 300. The AF moving unit 400 may be movably disposed. The AF moving unit 400 may move in an optical axis direction against the fixed unit 100, the OIS-y moving unit 200, and the OIS-x moving unit 300 by the AF drive unit 700. The AF moving unit 400 may move during AF driving.

The lens-driving device 10 may comprise an AF holder 410. The AF moving unit 400 may comprise an AF holder 410. The AF holder 410 may be a ‘bobbin’. The AF holder 410 may be an ‘AF carrier’. The AF holder 410 may be disposed inside the OIS-x holder 310. The AF holder 410 may be disposed inside the OIS-y holder 210. The AF holder 410 may be disposed inside the base 110. The AF holder 410 may be disposed on the base 110. The AF holder 410 may be disposed inside the cover 140. The AF holder 410 may be movably disposed in an optical axis direction.

The AF holder 410 may comprise a groove 411. The groove 411 may be an ‘AF guide ball accommodating groove’. An AF guide ball 830 may be disposed in the groove 411. The groove 411 may be in direct contact with the AF guide ball 830. The groove 411 may be disposed in an optical axis direction. The groove 411 may comprise a plurality of grooves. The groove 411 may comprise two grooves. The groove 411 may comprise a first groove being in contact with the AF guide ball 830 at two points, and a second groove being in contact with the AF guide ball 830 at one point. In a modified embodiment, both the first groove and the second groove may be in contact with the AF guide ball 830 at two points.

The AF holder 410 may comprise a groove. The groove may be an ‘AF magnet accommodating groove’. The groove may be formed on an outer surface of the AF holder 410. An AF magnet 720 may be disposed in the groove. The groove may be formed in a shape corresponding to the AF magnet 720.

The lens-driving device 10 may comprise a drive unit. The drive unit may move the moving unit against the fixed unit. The drive unit may comprise an AF drive unit 700. The drive unit may comprise OIS drive units 500 and 600. The drive unit may comprise a coil and a magnet.

The lens-driving device 10 may comprise an OIS-y drive unit 500. The OIS-y drive unit 500 may move the OIS-y moving unit 200 in a y-axis direction perpendicular to the optical axis direction. The OIS-y drive unit 500 may move the OIS-y holder 210 in a y-axis direction. The OIS-y drive unit 500 may move the OIS-y holder 210 in a y-axis direction through electromagnetic force. The OIS-y drive unit 500 may comprise a coil and a magnet.

When the OIS-y moving unit 200 is moved by the OIS-y drive unit 500, the OIS-x moving unit 300 and the AF moving unit 400 can move together with the OIS-y moving unit 200. The OIS-x moving unit 300 and the AF moving unit 400 can move together with the OIS-y moving unit 200 in a y-axis direction.

The lens-driving device 10 may comprise an OIS-y coil 510. The OIS-y drive unit 500 may comprise an OIS-y coil 510. The OIS-y coil 510 may interact with an OIS-y magnet 520. The OIS-y coil 510 may move the OIS-y magnet 520 in a y-axis direction. The OIS-y coil 510 may move the OIS-y magnet 520 in a y-axis direction through interaction with the OIS-y magnet 520. The OIS-y coil 510 may face the OIS-y magnet 520. The OIS-y coil 510 may face the OIS-y magnet 520. The OIS-y coil 510 may be disposed at a position corresponding to the OIS-y magnet 520. The OIS-y coil 510 may be overlapped with the OIS-y magnet 520 in an x-axis direction. The OIS-y coil 510 may be disposed in the substrate 120. The OIS-y coil 510 may be disposed at a position corresponding to the OIS-y magnet 520 in the substrate 120. The OIS-y coil 510 may be disposed in the base 110. The OIS-y coil 510 may be disposed on the side plate 142 of the cover 140. The OIS-y coil 510 may be disposed between the OIS-y magnet 520 and the cover 140. The OIS-y coil 510 can be disposed in the fixed unit 100.

The lens-driving device 10 may comprise an OIS-y magnet 520. The OIS-y drive unit 500 may comprise an OIS-y magnet 520. The OIS-y magnet 520 may be disposed in the OIS-y moving unit 200. The OIS-y magnet 520 may be disposed in the OIS-y holder 210. The OIS-y magnet 520 may be disposed on an outer surface of the OIS-y holder 210. The OIS-y magnet 520 may be fixed to the OIS-y holder 210. The OIS-y magnet 520 may be coupled to the OIS-y holder 210. The OIS-y magnet 520 may be bonded to the OIS-y holder 210 with an adhesive. The OIS-y magnet 520 may be disposed inside the cover 140. The OIS-y magnet 520 may interact with the OIS-y coil 510. The OIS-y magnet 520 may electromagnetically interact with the OIS-y coil 510. The OIS-y magnet 520 may be disposed at a position corresponding to the OIS-y coil 510. The OIS-y magnet 520 and the OIS-y coil 510 may face each other. The OIS-y magnet 520 may face the OIS-y coil 510. The OIS-y magnet 520 may be overlapped with the OIS-y coil 510 in a direction perpendicular to the optical axis.

The OIS-y magnet 520 may be a four-pole magnet. The OIS-y magnet 520 may comprise a four-pole magnetizing magnet. The OIS-y magnet 520 may comprise a first magnet unit comprising an N pole and an S pole, and a second magnet unit comprising an N pole and an S pole. The first magnet unit and the second magnet unit may be disposed in a horizontal direction. The first magnet unit and the second magnet unit may be disposed spaced apart from each other in a horizontal direction, and a neutral section may be disposed between the first magnet unit and the second magnet unit.

In the present embodiment, even when the OIS-y magnet 520 moves due to the interaction between the OIS-y coil 510 and the OIS-y magnet 520, the distance between the OIS-y coil 510 and the OIS-y magnet 520 can be maintained constant.

The lens-driving device 10 may comprise an OIS-y sensor 530. The OIS-y drive unit 500 may comprise an OIS-y sensor 530. The OIS-y sensor 530 may be disposed in a substrate 120. The OIS-y sensor 530 may comprise a Hall element (Hall IC). The OIS-y sensor 530 may comprise a Hall sensor. The OIS-y sensor 530 may detect an OIS-y magnet 520. The OIS-y sensor 530 may detect a magnetic force of the OIS-y magnet 520. The OIS-y sensor 530 may detect the movement of the OIS-y magnet 520. The amount of movement or position of the OIS-y magnet 520 detected by the OIS-y sensor 530 can be used for feedback of the optical image stabilization (OIS) driving in a y-axis direction.

The OIS-y sensor 530 may be disposed within the OIS-y coil 510. The OIS-y sensor 530 may be overlapped with the OIS-y coil 510 in an optical axis direction. The OIS-y sensor 530 may be overlap with the neutral portion of the OIS-y magnet 520 in an x-axis direction. In a modified embodiment, the OIS-y sensor 530 may be disposed at the outside of the OIS-y coil 510. The OIS-y sensor 530 may face the OIS-y magnet 520. The OIS-y sensor 530 may be disposed at a position corresponding to the OIS-y magnet 520.

The lens-driving device 10 may comprise an OIS-x drive unit 600. The OIS-x drive unit 600 may move the OIS-x moving unit 300 in an x-axis direction perpendicular to the optical axis direction and a y-axis direction. The OIS-x drive unit 600 may move the OIS-x holder 310 in an x-axis direction. The OIS-x drive unit 600 may move the OIS-x holder 310 in an x-axis direction through electromagnetic force. The OIS-x drive unit 600 may comprise a coil and a magnet.

When the OIS-x moving unit 300 is moved by the OIS-x drive unit 600, the AF moving unit 400 can move together with the OIS-x moving unit 300. The AF moving unit 400 can move together with the OIS-x moving unit 300 in an x-axis direction.

The lens-driving device 10 may comprise an OIS-x coil 610. The OIS-x drive unit 600 may comprise an OIS-x coil 610. The OIS-x coil 610 may interact with an OIS-x magnet 620. The OIS-x coil 610 may move the OIS-x magnet 620 in an x-axis direction. The OIS-x coil 610 may move the OIS-x magnet 620 in an x-axis direction through interaction with the OIS-x magnet 620. The OIS-x coil 610 and the OIS-x magnet 620 may face each other. The OIS-x coil 610 may face the OIS-x magnet 620. The OIS-x coil 610 may be disposed at a position corresponding to the OIS-x magnet 620. The OIS-x coil 610 may be overlapped with the OIS-x magnet 620 in a y-axis direction. The OIS-x coil 610 may be disposed in the substrate 120. The OIS-x coil 610 may be disposed at a position corresponding to the OIS-x magnet 620 in the substrate 120. The OIS-x coil 610 may be disposed in the base 110. The OIS-x coil 610 may be disposed in the side plate 142 of the cover 140. The OIS-x coil 610 may be disposed between the OIS-x magnet 620 and the cover 140. The OIS-x coil 610 can be disposed in the fixed unit 100.

The lens-driving device 10 may comprise an OIS-x magnet 620. The OIS-x drive unit 600 may comprise an OIS-x magnet 620. The OIS-x magnet 620 may be disposed in the OIS-x moving unit 300. The OIS-x magnet 620 may be disposed in the OIS-x holder 310. The OIS-x magnet 620 may be disposed on an outer surface of the OIS-x holder 310. The OIS-x magnet 620 may be fixed to the OIS-x holder 310. The OIS-x magnet 620 may be coupled to the OIS-x holder 310. The OIS-x magnet 620 may be attached to the OIS-x holder 310 with an adhesive. The OIS-x magnet 620 may be disposed inside the cover 140. The OIS-x magnet 620 may interact with the OIS-x coil 610. The OIS-x magnet 620 may electromagnetically interact with the OIS-x coil 610. The OIS-x magnet 620 may be disposed at a position corresponding to the OIS-x coil 610. The OIS-x magnet 620 and the OIS-x coil 610 may face each other. The OIS-x magnet 620 may face the OIS-x coil 610. The OIS-x magnet 620 may be overlapped with the OIS-x coil 610 in a direction perpendicular to the optical axis.

The OIS-x magnet 620 can be disposed in the hole 211 of the OIS-y holder 210. The OIS-x magnet 620 can be overlapped with the OIS-y holder 210 in an x-axis direction. The OIS-x magnet 620 can be overlapped with the OIS-y holder 210 in an optical axis direction.

The OIS-x magnet 620 may be a four-pole magnet. The OIS-x magnet 620 may comprise a four-pole magnetizing magnet. The OIS-x magnet 620 may comprise a first magnet unit comprising an N pole and an S pole, and a second magnet unit comprising an N pole and an S pole. The first magnet unit and the second magnet unit may be disposed in a horizontal direction. The first magnet unit and the second magnet unit may be disposed spaced apart from each other in a horizontal direction, and a neutral portion may be disposed between the first magnet unit and the second magnet unit.

In the present embodiment, even when the OIS-x magnet 620 moves due to the interaction between the OIS-x coil 610 and the OIS-x magnet 620, the distance between the OIS-x coil 610 and the OIS-x magnet 620 can be maintained constant.

The lens-driving device 10 may comprise an OIS-x sensor 630. The OIS-x drive unit 600 may comprise an OIS-x sensor 630. The OIS-x sensor 630 may be disposed in the substrate 120. The OIS-x sensor 630 may comprise a Hall element (Hall IC). The OIS-x sensor 630 may comprise a Hall sensor. The OIS-x sensor 630 may detect an OIS-x magnet 620. The OIS-x sensor 630 may detect a magnetic force of the OIS-x magnet 620. The OIS-x sensor 630 may detect movement of the OIS-x magnet 620. The amount of movement or position of the OIS-x magnet 620 detected by the OIS-x sensor 630 can be used for feedback of the optical image stabilization (OIS) drive in an x-axis direction.

The OIS-x sensor 630 may be disposed inside the OIS-x coil 610. The OIS-x sensor 630 may be overlapped with the OIS-x coil 610 in an optical axis direction. The OIS-x sensor 630 may be overlapped with the neutral portion of the OIS-x magnet 620 in a y-axis direction. In a modified embodiment, the OIS-x sensor 630 may be disposed at the outside of the OIS-x coil 610. The OIS-x sensor 630 may face the OIS-x magnet 620. The OIS-x sensor 630 may be disposed at a position corresponding to the OIS-x magnet 620.

The lens-driving device 10 may comprise an AF drive unit 700. The AF drive unit 700 may move the AF moving unit 400 in an optical axis direction. The AF drive unit 700 may move the AF holder 410 in an optical axis direction. The AF drive unit 700 may move the AF holder 410 in an optical axis direction through electromagnetic force. The AF drive unit 700 may comprise a coil and a magnet. The AF drive unit 700 may comprise a coil and a magnet interacting with each other.

When the OIS-x moving unit 300 and the AF moving unit 400 are moved by the OIS-x drive unit 600, the distance between the facing surfaces of the AF coil 710 and the AF magnet 720 may be changed. When the OIS-y moving unit 200, the OIS-x moving unit 300, and the AF moving unit 400 are moved by the OIS-y drive unit 500, the distance between the facing surfaces of the AF coil 710 and the AF magnet 720 does not vary, and the AF magnet 720 may be eccentric with respect to the AF coil 710.

The lens-driving device 10 may comprise an AF coil 710. The AF drive unit 700 may comprise an AF coil 710. The AF coil 710 may interact with an AF magnet 720. The AF coil 710 may be disposed at an opposite side of the OIS-y coil 510 with respect to the optical axis.

The AF coil 710 can move the AF magnet 720 in an optical axis direction. The AF coil 710 can move the AF magnet 720 in an optical axis direction through interaction with the AF magnet 720. The AF coil 710 and the AF magnet 720 can face each other. The AF coil 710 can face the AF magnet 720. The AF coil 710 can be disposed at a position corresponding to the AF magnet 720. The AF coil 710 can be overlapped with the AF magnet 720 in an x-axis direction. The AF coil 710 can be disposed in the substrate 120. The AF coil 710 can be disposed at a position corresponding to the AF magnet 720 in the substrate 120. The AF coil 710 may be disposed in the base 110. The AF coil 710 may be disposed in the side plate 142 of the cover 140. The AF coil 710 may be disposed between the AF magnet 720 and the cover 140. The AF coil 710 may be disposed in the fixed unit 100.

The lens-driving device 10 may comprise an AF magnet 720. The AF drive unit 700 may comprise an AF magnet 720. The AF magnet 720 may be disposed in the AF moving unit 400. The AF magnet 720 may be disposed in the AF holder 410. The AF magnet 720 may be disposed at an outer surface of the AF holder 410. The AF magnet 720 may be fixed to the AF holder 410. The AF magnet 720 may be coupled to the AF holder 410. The AF magnet 720 may be attached to the AF holder 410 with an adhesive. The AF magnet 720 may be disposed inside the cover 140. The AF magnet 720 may interact with the AF coil 710. The AF magnet 720 can electromagnetically interact with the AF coil 710. The AF magnet 720 can be disposed at a position corresponding to the AF coil 710. The AF magnet 720 and the AF coil 710 can face each other. The AF magnet 720 can face the AF coil 710. The AF magnet 720 can be overlapped with the AF coil 710 in a direction perpendicular to the optical axis.

The AF magnet 720 can be disposed in the hole 311 of the OIS-x holder 310. The AF magnet 720 can be overlapped with the OIS-x holder 310 in a y-axis direction. The AF magnet 720 can be overlapped with the OIS-x holder 310 in an optical axis direction.

The AF magnet 720 may be a four-pole magnet. The AF magnet 720 may comprise a four-pole magnetizing magnet. The AF magnet 720 may comprise a first magnet unit comprising an N pole and an S pole, and a second magnet unit comprising an N pole and an S pole. The first magnet unit and the second magnet unit may be disposed in a vertical direction. The first magnet unit and the second magnet unit may be disposed to be spaced apart from each other in a vertical direction, and a neutral portion may be disposed between the first magnet unit and the second magnet unit.

The lens-driving device 10 may comprise an AF sensor 730. The AF drive unit 700 may comprise an AF sensor 730. The AF sensor 730 may be disposed in the substrate 120. The AF sensor 730 may comprise a Hall element (Hall IC). The AF sensor 730 may comprise a Hall sensor. The AF sensor 730 may detect the AF magnet 720. The AF sensor 730 may detect the magnetic force of the AF magnet 720. The AF sensor 730 may detect the movement of the AF magnet 720. The movement amount or position of the AF magnet 720 detected by the AF sensor 730 may be used for feedback of auto focus (AF).

The AF sensor 730 may be disposed inside the AF coil 710. The AF sensor 730 may be overlapped with the AF coil 710 in an optical axis direction. The AF sensor 730 may be overlapped with the neutral portion of the AF magnet 720 in an x-axis direction. In a modified embodiment, the AF sensor 730 may be disposed at the outside of the AF coil 710. The AF sensor 730 may face the AF magnet 720. The AF sensor 730 may be disposed at a position corresponding to the AF magnet 720.

The AF sensor 730 may comprise a drive IC. In this case, the drive IC may be electrically connected to the AF coil 710. The drive IC may apply current to the AF coil 710.

The lens-driving device 10 may comprise a guide member. The guide member may comprise a ball. The guide member may comprise a pin. The guide member may comprise a cylindrical member. The guide member may guide movement of the moving unit relative to the fixed unit 100 in a specific direction.

The lens-driving device 10 may comprise an OIS-y guide ball 810. The OIS-y guide ball 810 may guide movement of the OIS-y holder 210 with respect to the base 110 in a y-axis direction. The OIS-y guide ball 810 may be disposed between the OIS-y moving unit 200 and the fixed unit 100 in an x-axis direction. The OIS-y guide ball 810 may be disposed between the base 110 and the OIS-y holder 210. The OIS-y guide ball 810 may be disposed between the base 110 and the OIS-y holder 210 in an x-axis direction. The OIS-y guide ball 810 may be disposed in a groove 113 of the base 110. The entire region from a lower end portion of the OIS-y guide ball 810 to an upper end may be overlapped with both the base 110 and the OIS-y holder 210 in an x-axis direction. The entire region of the OIS-y guide ball 810 may be overlapped with both the base 110 and the OIS-y holder 210 in an x-axis direction. The OIS-y guide ball 810 may be disposed between the inner surface of the base 110 and the outer surface of the OIS-y holder 210. When viewed from an outer side of the OIS-y holder 210, the OIS-y guide ball 810 may be overlapped with the OIS-y magnet 520 in a horizontal direction. At least a portion of the OIS-y guide ball 810 may be overlapped with the OIS-y magnet 520 in a y-axis direction.

The OIS-y guide ball 810 can be disposed between the groove 113 of the fixed unit 100 and the first groove 212 of the OIS-y moving unit 200. At least one of the groove 113 of the fixed unit 100 and the first groove 212 of the OIS-y moving unit 200 can be extended in a y-axis direction longer than the diameter of the OIS-y guide ball 810.

The OIS-y guide ball 810 may be disposed in the groove 113 of the base 110. The OIS-y guide ball 810 may be disposed in the first groove 212 of the OIS-y holder 210. The OIS-y guide ball 810 may comprise a first-first ball being in contact with the base 110 and the OIS-y holder 210 at four points, and a first-second ball being in contact with the base 110 and the OIS-y holder 210 at three points. The OIS-y guide ball 810 may be spherical. The OIS-y guide ball 810 may be formed of metal. Grease may be applied to the surface of the OIS-y guide ball 810.

The OIS-y guide ball 810 may comprise a plurality of balls. The OIS-y guide ball 810 may comprise four balls. Two OIS-y guide balls 810 may be disposed on one side of the OIS-y magnet 520, and the remaining two OIS-y guide balls 810 may be disposed on the other side of the OIS-y magnet 520.

The lens-driving device 10 may comprise an OIS-x guide ball 820. The OIS-x guide ball 820 may guide movement of the OIS-x holder 310 against the OIS-y holder 210 in an x-axis direction. The OIS-x guide ball 820 may be disposed between the OIS-y holder 210 and the OIS-x holder 310. The OIS-x guide ball 820 may be disposed between the OIS-y holder 210 and the OIS-x holder 310 in a y-axis direction. The entire region from a lower end portion of the OIS-x guide ball 820 to an upper end may be overlapped with both the OIS-y holder 210 and the OIS-x holder 310 in a y-axis direction. The entire region of the OIS-x guide ball 820 may be overlapped with the OIS-y holder 210 and the OIS-x holder 310 in a y-axis direction. The OIS-x guide ball 820 may be disposed between the inner surface of the OIS-y holder 210 and the outer surface of the OIS-x holder 310. When viewed from the outer side of the OIS-x holder 310, the OIS-x guide ball 820 may be overlapped with the OIS-x magnet 620 in a horizontal direction. At least a portion of the OIS-x guide ball 820 may be overlapped with the OIS-x magnet 620 in an x-axis direction.

The OIS-x guide ball 820 can be disposed between the second groove 213 of the OIS-y moving unit 200 and the first groove 312 of the OIS-x moving unit 300. At least one of the second groove 213 of the OIS-y moving unit 200 and the first groove 312 of the OIS-x moving unit 300 can be extended in an x-axis direction longer than the diameter of the OIS-x guide ball 820.

The OIS-x guide ball 820 may be disposed in the second groove 213 of the OIS-y holder 210. The OIS-x guide ball 820 may be disposed in the first groove 312 of the OIS-x holder 310. The OIS-x guide ball 820 may comprise a first-first ball being in contact with the OIS-y holder 210 and the OIS-x holder 310 at four points, and a first-second ball being in contact with the OIS-y holder 210 and the OIS-x holder 310 at three points. The OIS-x guide ball 820 may be spherical. The OIS-x guide ball 820 may be formed of metal. Grease may be applied to the surface of the OIS-x guide ball 820.

The OIS-x guide ball 820 may comprise multiple balls. The OIS-x guide ball 820 may comprise four balls. Two OIS-x guide balls 820 may be disposed on one side of the OIS-x magnet 620 and the remaining two OIS-x guide balls 820 may be disposed on the other side of the OIS-x magnet 620.

The lens-driving device 10 may comprise an AF guide ball 830. The AF guide ball 830 may guide movement of the AF holder 410 against the OIS-x holder 310 in an optical axis direction. The AF guide ball 830 may be disposed between the OIS-x holder 310 and the AF holder 410. The AF guide ball 830 may be disposed between the OIS-x holder 310 and the AF holder 410 in an x-axis direction. The AF guide ball 830 may be disposed between the inner side surface of the OIS-x holder 310 and the outer side surface of the AF holder 410. When viewed from the outer side of the AF holder 410, the AF guide ball 830 may be overlapped with the AF magnet 720 in a horizontal direction. When viewed from the top, at least a portion of the AF guide ball 830 may be overlapped with the AF magnet 720 in a y-axis direction. At least a portion of the AF guide ball 830 may be overlapped with the AF magnet 720 in a y-axis direction.

The AF guide ball 830 may be disposed between the second groove 213 of the OIS-x moving unit 300 and the groove 411 of the AF moving unit 400. At least one of the second groove 213 of the OIS-x moving unit 300 and the groove 411 of the AF moving unit 400 may be extended longer than the diameter of the AF guide ball 830 in an optical axis direction.

The AF guide ball 830 may be disposed in the second groove 313 of the OIS-x holder 310. The AF guide ball 830 may be disposed in the groove 411 of the AF holder 410. The AF guide ball 830 may comprise a first-first ball being in contact with the OIS-x holder 310 and the AF holder 410 at four points, and a first-second ball being in contact with the OIS-x holder 310 and the AF holder 410 at three points. The AF guide ball 830 may be spherical. The AF guide ball 830 may be formed of metal. Grease may be applied to the surface of the AF guide ball 830.

The AF guide ball 830 may comprise a plurality of balls. The AF guide ball 830 may comprise six balls. Three AF guide balls 830 may be disposed on one side of the AF magnet 720 and the remaining three AF guide balls 830 may be disposed on the other side of the AF magnet 720.

Hereinafter, the configuration of a lens-driving device according to a modified embodiment is described with reference to the drawings.

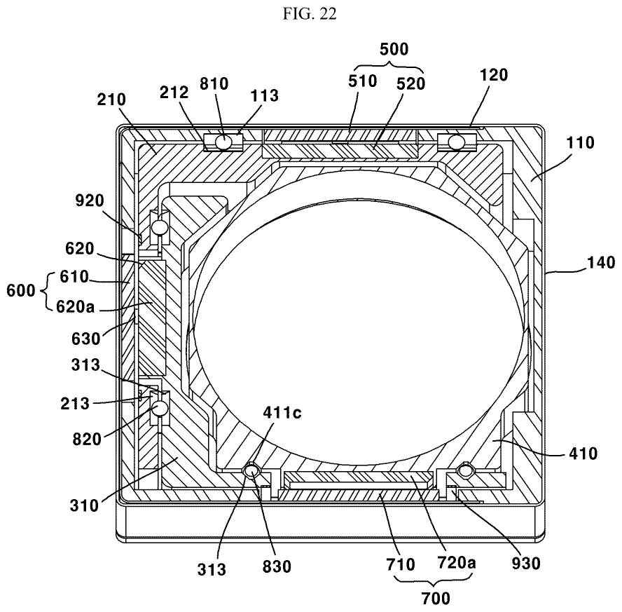

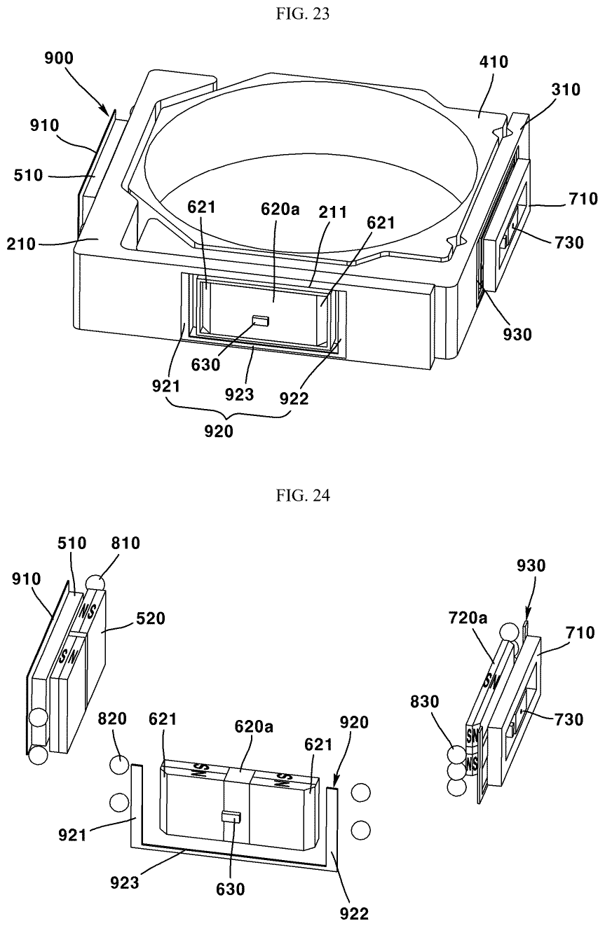

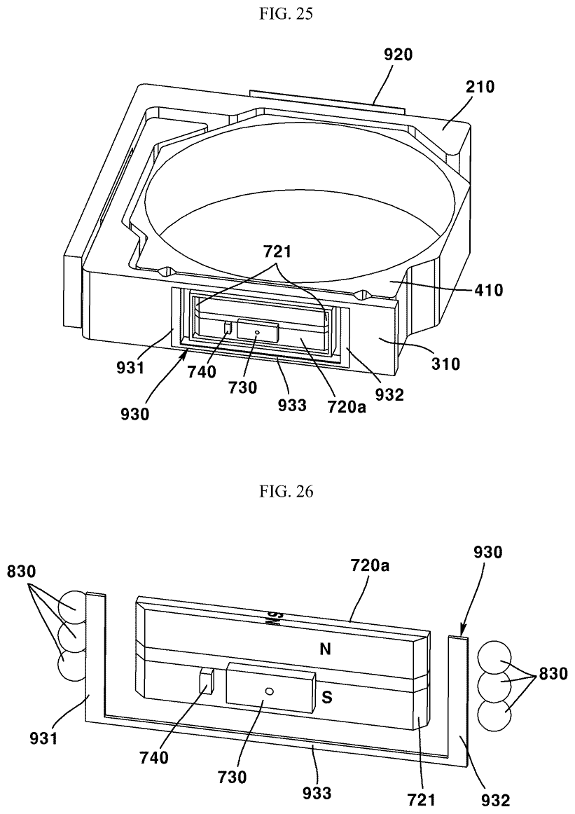

FIG. 22 is a cross-sectional perspective view of a lens-driving device according to a modified embodiment. FIG. 23 is a perspective view illustrating a moving unit and related components of a lens-driving device according to a modified embodiment. FIG. 24 is a perspective view illustrating a coil, a magnet, a yoke, a ball, and a sensor of a lens-driving device according to a modified embodiment. FIG. 25 is a perspective view illustrating a moving unit and related components of a lens-driving device according to a modified embodiment from a different direction than FIG. 23. FIG. 26 is a perspective view illustrating an AF magnet, an AF yoke, an AF guide ball, and an AF sensor of a lens-driving device according to a modified embodiment.

Hereinafter, the configuration of the lens-driving device 10 according to a modified embodiment will be described with a focus on the differences from the previous embodiment. Therefore, the technical configuration of the lens-driving device 10 according to the modified embodiment that is not described hereinafter can be applied analogically to the description in the previous embodiment.

In the lens-driving device 10 according to a modified embodiment, the shape and position of the OIS-x yoke 920 and the AF yoke 930 may be changed compared to the previous embodiment. In addition, in the lens-driving device 10 according to the modified embodiment, the OIS-x magnet 620a and the AF magnet 720a may additionally comprise chamfer surfaces 621 and 721 compared to the previous embodiment.

The lens-driving device 10 may comprise an attractive force member. The attractive force member may be a pressure member. The attractive force member may be a ball pressure member. A magnet and an attractive force may act on the attractive force member.

The lens-driving device 10 may comprise a yoke 900. The attractive force member may comprise the yoke 900. The yoke 900 may be formed of metal. An attractive force may be generated between the yoke 900 and the magnets 520, 620a, and 720a. The balls 810, 820, and 830 may be pressed by the attractive force between the yoke 900 and the magnets 520, 620a, and 720a.

The lens-driving device 10 may comprise an OIS-y yoke 910. The attractive force member may comprise the OIS-y yoke 910. The yoke 900 may comprise the OIS-y yoke 910. The OIS-y yoke 910 may be disposed on the fixed unit 100. An attractive force may act between the OIS-y yoke 910 and the OIS-y magnet 520. The OIS-y yoke 910 may be disposed in the substrate 120. The OIS-y yoke 910 may be disposed in a first portion of the substrate 120. The OIS-y yoke 910 may be disposed on an outer surface of a first portion of the substrate 120. The OIS-y yoke 910 may be disposed in the base 110. The OIS-y yoke 910 may be disposed in the cover 140. The OIS-y yoke 910 may be disposed at a position corresponding to the OIS-y magnet 520. An attractive force may be generated between the OIS-y yoke 910 and the OIS-y magnet 520. The OIS-y guide ball 810 may be pressed by the attractive force between the OIS-y yoke 910 and the OIS-y magnet 520. The OIS-y guide ball 810 may be pressed between the OIS-y holder 210 and the base 110 by the attractive force between the OIS-y yoke 910 and the OIS-y magnet 520.

In a modified embodiment, the OIS-y yoke 910 may be redisposed with a magnet. That is, the lens-driving device 10 may comprise an OIS-y attractive force magnet. An attractive force may act between the OIS-y attractive force magnet and the OIS-y magnet 520.

The lens-driving device 10 may comprise an OIS-x yoke 920. The attractive force member may comprise the OIS-x yoke 920. The yoke 900 may comprise the OIS-x yoke 920. The OIS-x yoke 920 may be disposed in the OIS-y moving unit 200. The OIS-x yoke 920 may be disposed in the OIS-y holder 210. The OIS-x yoke 920 may be disposed on an outer surface of the OIS-y holder 210. The OIS-x yoke 920 may be disposed in a groove of the OIS-y holder 210. The OIS-y holder 210 may comprise a groove in which the OIS-x yoke 920 is disposed. The OIS-y holder 210 may comprise a groove having a shape corresponding to the OIS-x yoke 920.

The OIS-x yoke 920 being disposed in the fixed unit 100 in the present modified embodiment may be disposed in the OIS-y moving unit 200 in a modified embodiment. In a modified embodiment, there may not be a significant change in the attractive force between the OIS-x yoke and the OIS-x magnet compared to the present modified embodiment. Nevertheless, there is an advantage in that the attractive force between the OIS-x yoke and the OIS-x magnet does not act as a resistance to the handshake correction drive in a y-axis direction. More specifically, in the present modified embodiment, the attractive force between the OIS-x yoke 132 and the OIS-x magnet 620 presses the OIS-x magnet 620 toward the fixed unit 100, so it may act as a resistance to the handshake correction driving in a y-axis direction. However, in a modified embodiment, the attractive force between the OIS-x yoke 920 and the OIS-x magnet 620a presses the OIS-x magnet 620a toward the OIS-y holder 210, but the OIS-y holder 210 moves in a y-axis direction, so it may not act as resistance.

The OIS-x yoke 920 can be disposed at a position corresponding to the OIS-x magnet 620a. The OIS-x yoke 920 can exert an attractive force on the OIS-x magnet 620a. An attractive force can be generated between the OIS-x yoke 920 and the OIS-x magnet 620a. The OIS-x guide ball 820 can be pressurized by the attractive force between the OIS-x yoke 920 and the OIS-x magnet 620a. The OIS-x guide ball 820 can be pressurized between the OIS-x holder 310 and the OIS-y holder 210 by the attractive force between the OIS-x yoke 920 and the OIS-x magnet 620a.

The OIS-x yoke 920 may comprise a first portion 921 disposed at one side of the OIS-x magnet 620a in an x-axis direction. The first portion 921 may be disposed to be long in an optical axis direction. The first portion 921 and the second portion 922 may be disposed parallel to an optical axis. The length of the first portion 921 in an optical axis direction may be longer than the length of the OIS-x magnet 620a in an optical axis direction. Alternatively, the length of the first portion 921 in an optical axis direction may be the same as the length of the OIS-x magnet 620a in an optical axis direction.

The OIS-x yoke 920 may comprise a second portion 922 disposed on the other side of the OIS-x magnet 620a in an x-axis direction. The second portion 922 may be disposed to be long in an optical axis direction. The second portion 922 may be disposed parallel to an optical axis. The length of the second portion 922 in an optical axis direction may be longer than the length of the OIS-x magnet 620a in an optical axis direction. Alternatively, the length of the second portion 922 in an optical axis direction may be the same as the length of the OIS-x magnet 620a in an optical axis direction.

The OIS-x yoke 920 may comprise a third portion 923 connecting the first portion 921 and the second portion 922. The third portion 923 of the OIS-x yoke 920 may be in connect with a lower end portion of the first portion 921 and a lower end portion of the second portion 922. In a modified embodiment, the third portion 923 may be omitted. In another modified embodiment, the third portion 923 of the OIS-x yoke 920 may connect an upper end portion of the first portion 921 and an upper end portion of the second portion 922.

In a modified embodiment, the OIS-x yoke 920 can be redisposed with a magnet. That is, the lens-driving device 10 can comprise an OIS-x attractive force magnet. Attractive force can act between the OIS-x attractive force magnet and the OIS-x magnet 620a.

The OIS-x magnet 620a may comprise a chamfered surface 621 being formed at a corner closest to the first portion 921 of the OIS-x yoke 920. The OIS-x magnet 620a may comprise a chamfered surface 621 being formed at a corner closest to the second portion 922 of the OIS-x yoke 920. The attractive force between the OIS-x magnet 620a and the OIS-x yoke 920 may be strengthened through the chamfered surface 621.

The OIS-x yoke 920 may be overlapped with the OIS-x magnet 620a in an x-axis direction. Alternatively, in a modified embodiment, the OIS-x yoke 920 may not be overlapped with the OIS-x magnet 620a in an x-axis direction.

The lens-driving device 10 may comprise an AF yoke 930. The attractive force member may comprise the AF yoke 930. The yoke 900 may comprise the AF yoke 930. The AF yoke 930 may be disposed in the OIS-x moving unit 300. The AF yoke 930 may be disposed in the OIS-x holder 310. The AF yoke 930 may be disposed on an outer surface of the OIS-x holder 310. The AF yoke 930 may be disposed in a groove of the OIS-x holder 310. The OIS-x holder 310 may comprise a groove in which the AF yoke 930 is disposed. The OIS-x holder 310 may comprise a groove having a shape corresponding to the AF yoke 930.

In the present modified embodiment, the AF yoke 930 being disposed in the fixed unit 100 may be disposed in the OIS-x moving unit 300 in a modified embodiment. In a modified embodiment, there may not be a significant change in the attractive force between the AF yoke and the AF magnet compared to the present modified embodiment. Nevertheless, there is an advantage in that the attractive force between the AF yoke and the AF magnet does not act as a resistance to the handshake correction driving in an x-axis direction. More specifically, in the present modified embodiment, the attractive force between the AF yoke 133 and the AF magnet 720 presses the AF magnet 720 toward the fixed unit 100, so it may act as a resistance to the shake correction drive in a y-axis direction. However, in a modified embodiment, the attractive force between the AF yoke 930 and the AF magnet 720a presses the AF magnet 720a toward the OIS-x holder 310, but since the OIS-x holder 310 moves in an x-axis direction, so it may not act as resistance.

The AF yoke 930 may be disposed at a position corresponding to the AF magnet 720a. The AF yoke 930 may exert an attractive force on the AF magnet 720a. Attractive force may be generated between the AF yoke 930 and the AF magnet 720a. The AF guide ball 830 may be pressed by the attractive force between the AF yoke 930 and the AF magnet 720a. The AF guide ball 830 may be pressed between the OIS-x holder 310 and the AF holder 410 by the attractive force between the AF yoke 930 and the AF magnet 720a.

The AF yoke 930 may comprise a first portion 931 disposed on one side of the AF magnet 720a in the y-axis direction. The first portion 931 may be disposed to be long in the optical axis direction. The first portion 931 and the second portion 932 may be disposed parallel to each other. The first portion 931 and the second portion 932 may be disposed parallel to the optical axis. The length of the first portion 931 in an optical axis direction may be longer than the length of the AF magnet 720a in an optical axis direction. Alternatively, the length of the first portion 931 in an optical axis direction may be equal to the length of the AF magnet 720a in an optical axis direction.

The AF yoke 930 may comprise a second portion 932 being disposed on the other side of the AF magnet 720a in a y-axis direction. The second portion 932 may be disposed to be long in an optical axis direction. The second portion 932 may be disposed parallel to an optical axis. The length of the second portion 932 in an optical axis direction may be longer than the length of the AF magnet 720a in an optical axis direction. Alternatively, the length of the second portion 932 in an optical axis direction may be equal to the length of the AF magnet 720a in an optical axis direction.

The AF yoke 930 may comprise a third portion 933 connecting the first portion 931 and the second portion 932. The third portion 933 of the AF yoke 930 may connect a lower end portion of the first portion 931 and a lower end portion of the second portion 932. In a modified embodiment, the third portion 933 may be omitted. In another modified embodiment, the third portion 933 of the AF yoke 930 may connect the upper end portion of the first portion 931 and the upper end portion of the second portion 932.

In a modified embodiment, the AF yoke 930 may be redisposed with a magnet. That is, the lens-driving device 10 may comprise an AF attraction force magnet. An attraction force may be applied between the AF attraction force magnet and the AF magnet 720a.

The AF magnet 720a may comprise a chamfer surface 721 being formed at a corner closest to the first portion 931 of the AF yoke 930. The AF magnet 720a may comprise a chamfer surface 721 being formed at a corner closest to the second portion 932 of the AF yoke 930. The attractive force between the AF magnet 720a and the AF yoke 930 may be strengthened through the chamfer surface 721.

The AF yoke 930 may not be overlapped with the AF magnet 720a in a y-axis direction. Alternatively, in a modified embodiment, the AF yoke 930 may be overlapped with the AF magnet 720a in a y-axis direction.

Hereinafter, the auto focus (AF) operation of the lens-driving device according to the modified embodiment is described with reference to the drawings.

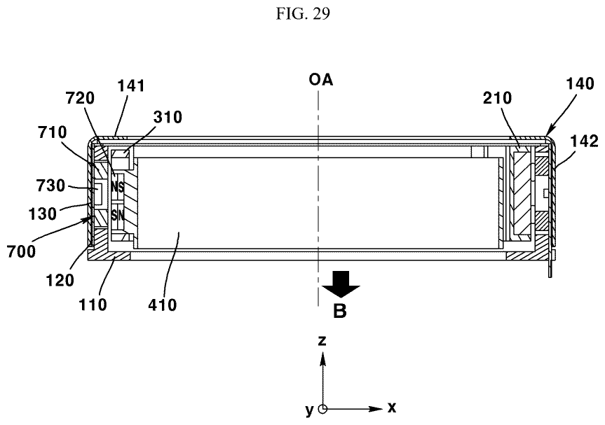

FIGS. 27 to 29 are diagrams for explaining an auto focus driving of a lens-driving device according to the present embodiment. FIG. 27 is a cross-sectional view illustrating an appearance of the AF moving unit in an initial state in which no current is applied to an AF coil. FIG. 28 is a cross-sectional view illustrating an appearance in which an AF moving unit moves upward in an optical axis direction when a forward current is applied to an AF coil. FIG. 29 is a cross-sectional view illustrating an appearance in which an AF moving unit moves downward in an optical axis direction when a reverse current is applied to an AF coil.

The moving unit may be disposed at a position spaced apart from both the upper plate 141 of the cover 140 and the base 110 in the initial position where no current is applied to the AF coil 710. At this time, the moving unit may be an AF moving unit 400.

When a positive current is applied to the AF coil 710, the AF magnet 720 can move upward in an optical axis direction due to the electromagnetic interaction between the AF coil 710 and the AF magnet 720 (see A of FIG. 28). At this time, the AF holder 410 can move upward in an optical axis direction together with the AF magnet 720. Furthermore, the lens can move upward in an optical axis direction together with the AF holder 410. Accordingly, the distance between the lens and the image sensor can be changed, and the focus of the image being formed on the image sensor through the lens can be adjusted.

When a reverse current is applied to the AF coil 710, the AF magnet 720 can move downward in an optical axis direction due to the electromagnetic interaction between the AF coil 710 and the AF magnet 720 (see B of FIG. 29). At this time, the AF holder 410 can move downward in an optical axis direction together with the AF magnet 720. Furthermore, the lens can move downward in an optical axis direction together with the AF holder 410. Accordingly, the distance between the lens and the image sensor can be changed, and the focus of the image being formed on the image sensor through the lens can be adjusted.

Meanwhile, during the movement process of the AF magnet 720, the AF sensor 730 can detect the strength of the magnetic field of the AF magnet 720 to detect the amount of movement or position of the AF magnet 720. The amount of movement or position of the AF magnet 720 detected by the AF sensor 730 can be used for auto focus feedback control.

Hereinafter, the optical image stabilization (OIS) operation of the lens-driving device according to the modified embodiment is described with reference to the drawings.

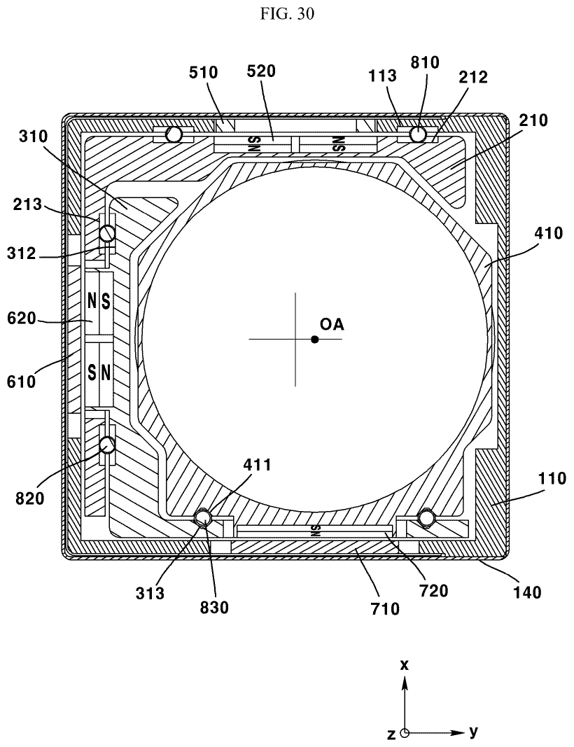

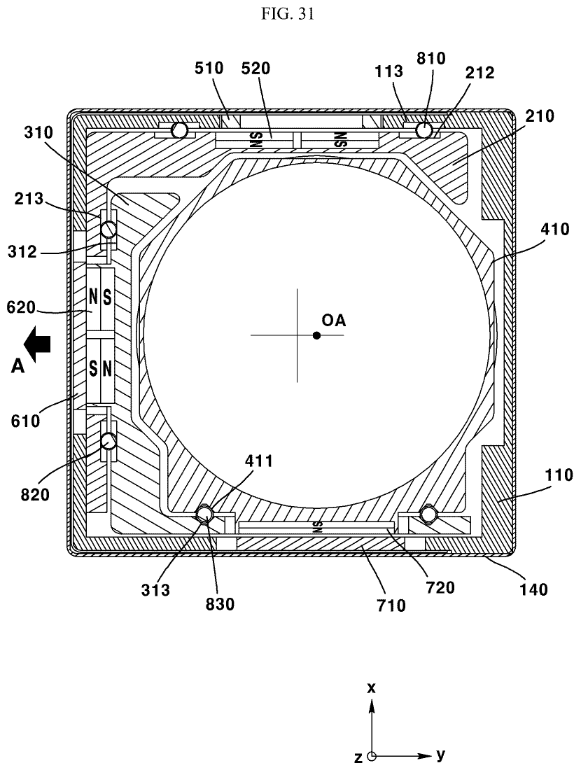

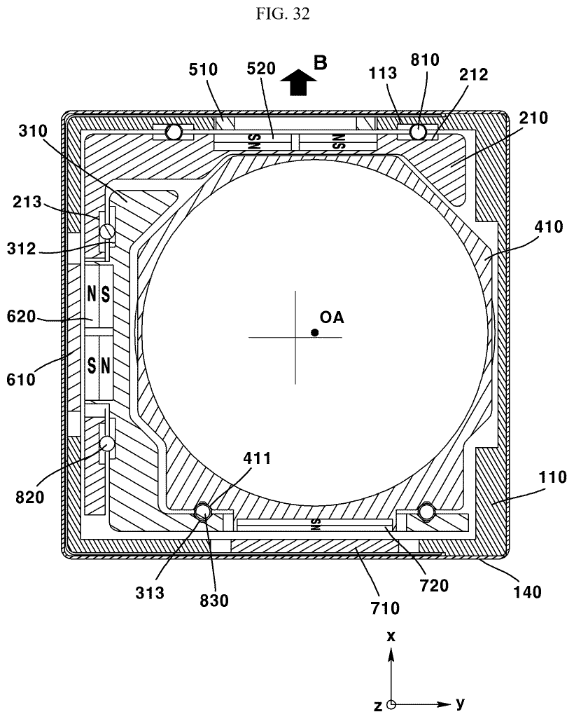

FIGS. 30 to 32 are diagrams for explaining a handshake correction driving of a lens-driving device according to the present embodiment. FIG. 30 is a cross-sectional view illustrating the appearance of a moving unit in an initial state in which no current is applied to an OIS-y coil and an OIS-x coil. FIG. 31 is a cross-sectional view illustrating an appearance in which an OIS-x moving unit, an OIS-y moving unit, and an AF moving unit that have been moved in a y-axis direction perpendicular to the optical axis when current is applied to an OIS-y coil. FIG. 32 is a cross-sectional view illustrating an appearance in which an OIS-x moving unit and an AF moving unit that have been moved in an x-axis direction perpendicular to the optical axis when current is applied to an OIS-x coil.

As illustrated in FIG. 30, the moving unit may be disposed at an initial position where no current is applied to the OIS-y coil 510 and the OIS-x coil 610. At this time, the moving unit may be the OIS-y moving unit 200 and the OIS-x moving unit 300. In addition, the moving unit may comprise the OIS-y moving unit 200, the OIS-x moving unit 300, and the AF moving unit 400.

When a current is applied to the OIS-y coil 510, the OIS-y magnet 520 can move in a y-axis direction perpendicular to the optical axis due to the electromagnetic interaction between the OIS-y coil 510 and the OIS-y magnet 520 (see A of FIG. 31). At this time, the OIS-y holder 210 can move in a y-axis direction together with the OIS-y magnet 520. Furthermore, the OIS-x holder 310, the AF holder 410, and the lens can move in a y-axis direction together with the OIS-y holder 210. In more detail, when a forward current is applied to the OIS-y coil 510, the OIS-y magnet 520, the OIS-y holder 210, the OIS-x holder 310, the AF holder 410, and the lens can move in one direction along a y-axis. In addition, when a reverse current is applied to the OIS-y coil 510, the OIS-y magnet 520, the OIS-y holder 210, the OIS-x holder 310, the AF holder 410, and the lens can move in the other direction along an x-axis.

When a current is applied to the OIS-x coil 610, the OIS-x magnet 620 can move in an x-axis direction perpendicular to the optical axis due to the electromagnetic interaction between the OIS-x coil 610 and the OIS-x magnet 620 (see B of FIG. 32). At this time, the OIS-x holder 310 can move in an x-axis direction together with the OIS-x magnet 620. Furthermore, the AF holder 410 and the lens can move in an x-axis direction together with the OIS-x holder 310. In more detail, when a positive current is applied to the OIS-x coil 610, the OIS-x magnet 620, the OIS-x holder 310, the AF holder 410, and the lens can move in one direction along an x-axis. In addition, when a reverse current is applied to the OIS-x coil 610, the OIS-x magnet 620, the OIS-x holder 310, the AF holder 410, and the lens can move in the other direction along the x-axis.

Meanwhile, the OIS-y sensor 530 can detect the amount of movement or position of the OIS-y magnet 520 by detecting the strength of the magnetic field of the OIS-y magnet 520. The amount of movement or position of the OIS-y magnet 520 detected by the OIS-y sensor 530 can be used for y-axis direction handshake correction feedback control. The OIS-x sensor 630 can detect the amount of movement or position of the OIS-x magnet 620 by detecting the strength of the magnetic field of the OIS-x magnet 620. The amount of movement or position of the OIS-x magnet 620 detected by the OIS-x sensor 630 can be used for x-axis direction handshake correction feedback control.

Hereinafter, a camera device according to the present modified embodiment is described with reference to the drawings.

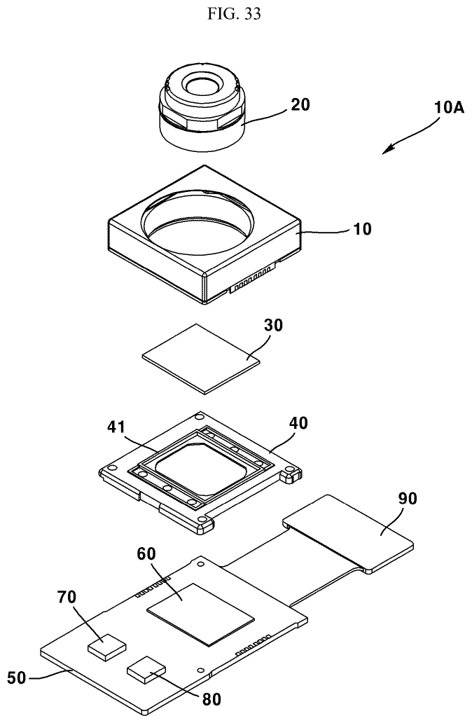

FIG. 33 is an exploded perspective view of a camera device according to the present embodiment.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to an AF holder 410 of the lens-driving device 10. The lens module 20 may be coupled to the AF holder 410 by screw-coupling and/or adhesive. The lens module 20 may be moved integrally with the AF holder 410.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light in an infrared region from being incident on the image sensor 60.

The camera device 10A may comprise a sensor base 40. The sensor base 40 may be disposed between the lens-driving device 10 and the printed circuit board 50. The sensor base 40 may comprise a protruded portion 41 in which a filter 30 is disposed. An opening may be formed in a portion of the sensor base 40 in which the filter 30 is disposed so that light passing through the filter 30 may be incident on the image sensor 60. An adhesive member may couple or attach the base 110 of the lens-driving device 10 to the sensor base 40. The adhesive member may additionally serve to prevent foreign substances from entering the interior of the lens-driving device 10. The adhesive member may comprise at least one among an epoxy, a thermosetting adhesive, and an ultraviolet-curable adhesive.

The camera device 10A may comprise a printed circuit board (PCB) 50. The printed circuit board 50 may be a substrate or a circuit board. A lens-driving device 10 may be disposed in the printed circuit board 50. A sensor base 40 may be disposed between the printed circuit board 50 and the lens-driving device 10. The printed circuit board 50 may be electrically connected to the lens-driving device 10. An image sensor 60 may be disposed in the printed circuit board 50. Various circuits, elements, control units, and the like may be provided in the printed circuit board 50 to convert an image formed on the image sensor 60 into an electrical signal and transmit it to an external device.

The camera device 10A may comprise an image sensor 60. The image sensor 60 may be configured such that light passing through a lens and a filter 30 is incident to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light being irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided in the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed in a printed circuit board 50. The control unit 80 may be electrically connected to a coil 330 of a lens-driving device 10. The control unit 80 may individually control the direction, intensity, and amplitude of current supplied to the coil 330. The control unit 80 may control the lens-driving device 10 to perform an auto-focus function and/or a handshake correction function. Furthermore, the control unit 80 may perform auto-focus feedback control and/or handshake correction feedback control for the lens-driving device 10.

The camera device 10A may comprise a connector 90. The connector 90 may be electrically connected to a printed circuit board 50. The connector 90 may comprise a port for being electrically connected to an external device.

Hereinafter, an optical device according to the present modified embodiment is described with reference to drawings.

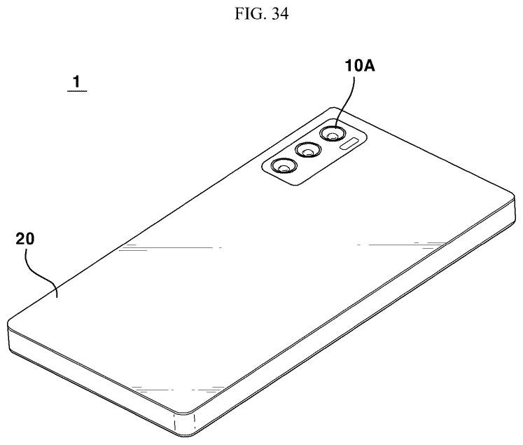

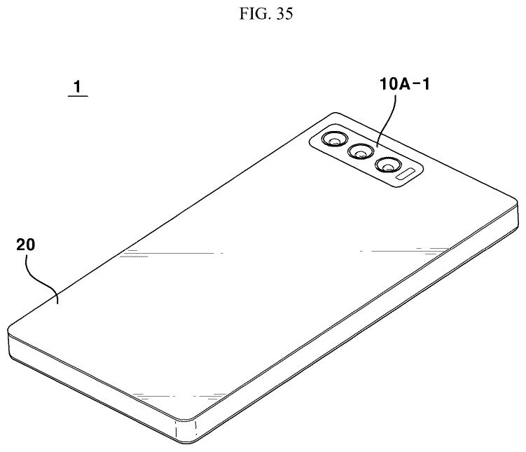

FIG. 34 is a perspective view of an optical device according to the present embodiment; and FIG. 35 is a perspective view of an optical device according to a modified embodiment.

The optical device 1 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1 may comprise any device for photographing images or pictures.

The optical device 1 may comprise a main body 20. The optical device 1 may comprise a camera device 10A. The camera device 10A may be disposed in the main body 20. The camera device 10A may photograph a subject. The optical device 1 may comprise a display. The display may be disposed in the main body 20. The display may output one or more of an image and a video photographed by the camera device 10A. The display may be disposed on a first surface of the main body 20. The camera device 10A may be disposed on one or more of the first surface of the main body 20 and the second surface opposite to the first surface. As illustrated in FIG. 34, the camera device 10A may have a triple camera disposed in a vertical direction. As illustrated in FIG. 35, the camera device 10A-1 may have a triple camera disposed in a horizontal direction.

Although the present modified embodiment of the present invention has been described with reference to the attached drawings, those skilled in the art will understand that the present invention can be implemented in other specific forms without changing the technical idea or essential characteristics thereof. Therefore, it should be understood that the modified embodiments described above are exemplary in all respects and not restrictive.

1. A lens-driving device comprising:
a fixed unit;
a first moving unit disposed in the fixed unit;
a second moving unit disposed in the first moving unit;
a third moving unit disposed in the second moving unit;
a first drive unit configured to move the first moving unit in a first direction perpendicular to an optical axis direction;
a second drive unit configured to move the second moving unit in a second direction perpendicular to the optical axis direction and the first direction; and
a third drive unit configured to move the third moving unit in the optical axis direction.

2. The lens-driving device of claim 1, wherein when the first moving unit is moved by the first drive unit, the second moving unit and the third moving unit move together with the first moving unit.

3. The lens-driving device of claim 1, wherein when the second moving unit is moved by the second drive unit, the third moving unit moves together with the second moving unit.

4. The lens-driving device of claim 1, wherein the third drive unit comprises a third coil and a third magnet interacting with each other, and
wherein when the second moving unit and the third moving unit are moved by the second drive unit, a distance between facing surfaces of the third coil and the third magnet is changed.

5. The lens-driving device of claim 1, comprising:
a first ball disposed between the first moving unit and the fixed unit in the second direction.

6. The lens-driving device of claim 5, wherein the fixed unit comprises a groove,
wherein the first moving unit comprises a first groove,
wherein the first ball is disposed between the groove of the fixed unit and the first groove of the first moving unit, and
wherein at least one of the groove of the fixed unit and the first groove of the first moving unit extends in the first direction longer than a diameter of the first ball.

7. The lens-driving device of claim 1, wherein the first moving unit comprises a first portion disposed between the second moving unit and the fixed unit in the first direction, and
wherein a second ball is disposed between the first portion of the first moving unit and the second moving unit in the first direction.

8. The lens-driving device of claim 7, wherein the first moving unit comprises a second groove formed on the first portion of the first moving unit,
wherein the second moving unit comprises a first groove,
wherein the second ball is disposed between the second groove of the first moving unit and the first groove of the second moving unit, and
wherein at least one of the second groove of the first moving unit and the first groove of the second moving unit extends in the second direction longer than a diameter of the second ball.

9. The lens-driving device of claim 1, wherein the second moving unit comprises a first portion disposed between the third moving unit and the fixed unit in the second direction, and
wherein a third ball is disposed between the first portion of the second moving unit and the third moving unit in the second direction.

10. The lens-driving device of claim 9, wherein the second moving unit comprises a second groove formed on the first portion of the second moving unit,
wherein the third moving unit comprises a groove,
wherein the third ball is disposed between the second groove of the second moving unit and the groove of the third moving unit, and
wherein at least one of the second groove of the second moving unit and the groove of the third moving unit extends longer than a diameter of the third ball in the optical axis direction.

11. The lens-driving device of claim 5, wherein the fixed unit comprises a substrate,
wherein the first drive unit comprises a first magnet disposed on the first moving unit, and a first coil disposed on the substrate at a position corresponding to the first magnet, and
wherein at least a portion of the first ball is overlapped with the first magnet in the first direction.

12. The lens-driving device of claim 7, wherein the fixed unit comprises a substrate,
wherein the second drive unit comprises a second magnet disposed on the second moving unit, and a second coil disposed on the substrate at a position corresponding to the second magnet, and
wherein at least a portion of the second ball is overlapped with the second magnet in the second direction.

13. The lens-driving device of claim 9, wherein the fixed unit comprises a substrate,
wherein the third drive unit comprises a third magnet disposed on the third moving unit, and a third coil disposed on the substrate at a position corresponding to the third magnet, and
wherein at least a portion of the third ball is overlapped with the third magnet in the first direction.

14. The lens-driving device of claim 1, wherein the first drive unit comprises a first magnet disposed on the first moving unit,
wherein a first yoke is disposed on the fixed unit, and
wherein an attractive force acts between the first magnet and the first yoke.

15. The lens-driving device of claim 1, wherein the second drive unit comprises a second magnet disposed on the second moving unit,
wherein a second yoke is disposed in the first moving unit, and
wherein an attractive force acts between the second magnet and the second yoke.

16. The lens-driving device of claim 15, wherein the second yoke comprises a first portion disposed on one side of the second magnet in the second direction, and a second portion disposed on another side of the second magnet in the second direction, and
wherein the second magnet comprises a chamfer surface formed at an edge closest to each of the first portion and the second portion of the second yoke.

17. The lens-driving device of claim 1, wherein the third drive unit comprises a third magnet disposed on the third moving unit,
wherein a third yoke is disposed in the second moving unit, and
wherein an attractive force acts between the third magnet and the third yoke.

18. The lens-driving device of claim 1, wherein the third yoke comprises a first portion disposed on one side of the third magnet in the first direction, and a second portion disposed on another side of the third magnet in the first direction, and
wherein the third magnet comprises a chamfer surface formed at an edge closest to each of the first portion and the second portion of the third yoke.

19. A camera device comprising:
a printed circuit board;
an image sensor disposed on the printed circuit board;
the lens-driving device of claim 1 disposed on the printed circuit board; and
a lens coupled with the lens-driving device.

20. An optical device comprising:
a main body;
the camera device of claim 19 disposed on the main body; and
a display disposed on the main body and configured to output at least one of an image and a video photographed by the camera device.
